(19) United States
(12) Patent Application Publication
(10) Pub. No.: US 2014/0068978 A1
(43) Pub. Date: Mar. 13, 2014

(54) GREETING CARD FLAG

(71) Applicant: EVERGREEN ENTERPRISES, INC., Richmond, VA (US)

(72) Inventors: Timothy Lamm, Midlothian, VA (US); Suzy Smithson, Richmond, VA (US); Kimberly Oliver, Orange Park, FL (US)

(73) Assignee: EVERGREEN ENTERPRISES, INC., Richmond, VA (US)

(21) Appl. No.: 13/837,190

(22) Filed: Mar. 15, 2013

Related U.S. Application Data
(60) Provisional application No. 61/697,991, filed on Sep. 7, 2012.
(60) Provisional application No. 61/739,890, filed on Dec. 20, 2012.

(51) Int. Cl. B42D 15/04

(52) U.S. Cl. CPC B42D 15/045
USPC 40/124.09; 493/374; 493/267

(57) ABSTRACT

A greeting card flag includes one or more panels removeably attached to a decorative flag in a specific pattern enabling the decorative flag and attached panel(s) to fold into a greeting card shape. A recipient can open and read the greeting card flag as one would a standard greeting card before removing the panel(s) and displaying the decorative flag as one would display a standard decorative flag. The greeting card flag may also include connected panels allowing for a recipient to remove the panels without changing the relative positions of the panels and further allowing a recipient to reassemble the panels into a greeting card. A foldable flag hanger may be inserted into an envelope. When unfolded, the hanger supports a flag for display or decoration.

### CROSS-REFERENCE TO RELATED APPLICATIONS

This application claims the benefit of U.S. Provisional Applications No. 61/739,890 and 61/697,991, filed Dec. 20, 2012 and Sep. 7, 2012, respectively. The contents of each of these applications are expressly incorporated herein by reference.

### FIELD OF THE INVENTION

The field of the invention generally relates to greeting cards and decorative flags. More specifically, the invention relates to a greeting card incorporated together with a decorative flag or other articles, and to flag hangers for use with greeting cards incorporated together with decorative flags.

### BACKGROUND OF THE INVENTION

The greeting card industry is a constantly expanding business centered on people giving blank or pre-filled cards to others. The cards may contain text or graphics focused on a certain theme, such as a holiday or a birthday, or may simply be blank. Generally, the greeting card is made from a piece of paper or cardstock that is folded and then placed in a mailing envelope usually no larger than 9 inches on a side. The recipient will open the envelope and will generally see one panel of the folded greeting card at a time as he or she takes the card out of the envelope and opens the card.

In a separate industry, the sale and display of decorative flags is prevalent in many locales. Decorative flags, also known as home flags or garden flags, are usually small flags of about 12 inches by 18 inches that are designed to be placed in and/or around a home as decoration. Decorative flags, however, can come in various other shapes and sizes. Often, these decorative flags may have text or graphics focused on a certain theme, such as a holiday or a season. Such text or graphics may be applied in various methods, including, but not limited to, appliqué and dye sublimation.

### SUMMARY OF THE INVENTION

The invention relates to various exemplary embodiments, including articles, greeting cards, greeting card flags, and various methods of using the same.

These and other features and advantages of the invention are described below with reference to the accompanying drawings.

### BRIEF DESCRIPTION OF THE DRAWINGS

FIG. 1A is a view of a second side an embodiment of the greeting card flag.

FIG. 1B is a view of a second side an embodiment of the greeting card flag.

FIG. 2 is a view of a first side of an embodiment of the greeting card flag

FIG. 3 is a partial cross sectional view of an embodiment of the greeting card flag taken along line A-A of FIG. 2.

FIG. 4 is a partial, close-up view of a first side of an embodiment of the greeting card of FIG. 2 showing a portion of a panel peeled back.

FIG. 5 is a view of the greeting card flag of FIG. 2 in a folded configuration showing the cover panel.

FIG. 6 is a view of the greeting card flag of FIG. 2 in a folded configuration showing the inside panels.

FIG. 7 is a view of the greeting card flag of FIG. 2 in a folded configuration showing the rear panel.

FIG. 8 is a view of the greeting card flag of FIG. 2 in a folded configuration and an accompanying mailing envelope.

FIG. 9 is a view of a first side of an alternate embodiment of the greeting card flag.

FIG. 10 is a partial cross sectional view of an embodiment of the greeting card flag taken along line B-B of FIG. 9.

FIG. 11 is a view of the greeting card flag of FIG. 9 showing a set of panels in a greeting card configuration without the presence of the flag portion.

FIG. 12 is a view of the hanger of the greeting card flag of FIG. 9 shown in a folded configuration.

FIG. 13 is a view of the hanger of the greeting card flag of FIG. 9 shown in an unfolded configuration.

FIG. 14 is a view of several stages of an embodiment of the greeting card flag of FIG. 2 showing the greeting card flag transitioning from a greeting card flag in a mailing envelope to an unfolded configuration and to a greeting card configuration and a flag portion hanging on a hanger.

FIG. 15 is a view of a first side of an alternate embodiment of the greeting card flag with a separable piece.

FIG. 16A is a view of an alternate embodiment of a greeting card flag showing a single panel attached to a flag portion.

FIG. 16B is a side view of the greeting card flag of FIG. 16A.

FIG. 17A is a view of the greeting card flag of FIG. 16A showing the flag portion being folded upwards in half.

FIG. 17B is a side view of the greeting card flag of FIG. 16A showing the flag portion being folded upwards in half.

FIG. 17C is a view of the greeting card flag of FIG. 16A after being folded into a greeting card configuration, including a mailing envelope into which the greeting card flag may be inserted.

FIG. 18A is a view of an alternate embodiment of a greeting card flag showing a single panel attached to a flag portion.

FIG. 18B is a view of the greeting card flag of FIG. 18A showing the flag portion having been folded along several fold lines.

FIG. 18C is a view of the greeting card flag of FIG. 18a after being folded into a greeting card configuration, including a mailing envelope into which the greeting card flag may be inserted.

FIG. 19A is a view of an alternate embodiment of a greeting card flag showing a single panel attached to a flag portion, wherein the flag portion is a tea towel.

FIG. 19B is a view of the greeting card flag of FIG. 19A showing the tea towel flag portion having been folded along a fold line.

FIG. 19C is a view of the greeting card flag of FIG. 19A, containing a flag portion that is a tea towel, after being folded into a greeting card configuration, including a mailing envelope into which the greeting card flag may be inserted.

FIG. 20A is a view of an alternate embodiment of a greeting card flag showing a single panel attached to a flag portion, wherein the flag portion is a wine bag.

FIG. 20B is a view of the greeting card flag of FIG. 20A showing the wine bag flag portion having been folded along several fold lines.

FIG. 20C is a view of the greeting card flag of FIG. 20A, containing a flag portion that is a wine bag, after being folded into a greeting card configuration, including a mailing envelope into which the greeting card flag may be inserted.

FIG. 21A is a view of an alternate embodiment of a greeting card flag showing a single panel attached to a flag portion, wherein the flag portion is a grocery bag.

FIG. 21B is a view of the greeting card flag of FIG. 21A showing the grocery bag flag portion having been folded along several fold lines.

FIG. 21C is a view of the greeting card flag of FIG. 21A, containing a flag portion that is a grocery bag, after being folded into a greeting card configuration, including a mailing envelope into which the greeting card flag may be inserted.

FIG. 22A is a view of an embodiment of a point-of-sale container.

FIG. 22B is a view of a mailing envelope containing a greeting card flag being positioned into the point-of-sale container of FIG. 22A.

FIG. 22C is a view of the point-of-sale container of FIG. 22A after being closed.

FIG. 22D is a view of the point-of-sale container of FIG. 22A showing a flag hanger inserted under the flap.

FIG. 23 is a view of a portion of a point-of-sale display showing a set of point-of-sale containers hanging on display next to a flag portion hanging from a flag hanger in a display configuration.

FIG. 24A is a view of an alternate embodiment of a greeting card flag showing a single flag portion attached to a single panel.

FIG. 24B is a side view of the greeting card flag of FIG. 24A.

FIG. 25A is a view of the greeting card flag of FIG. 24A shown in a greeting card configuration.

FIG. 25B is a side view of the greeting card flag of FIG. 25A.

FIG. 25C is a view of the greeting card flag of FIG. 24A shown in an envelope configuration.

FIG. 26A is a rear view of the greeting card flag of FIG. 24A.

FIG. 26B is a front view of the greeting card flag of FIG. 24A after the hanger section has been separated.

FIG. 27A is a rear view of the greeting card flag of FIG. 26B.

FIG. 27B is a view of the panel of the greeting card flag of FIG. 24A after the hanger section and envelope flap have been removed.

FIG. 27C is a view of the greeting card flag of FIG. 27B shown in a greeting card configuration.

FIG. 28A is a view of an alternate embodiment of a greeting card flag showing a single panel attached to a flag portion.

FIG. 28B is a side view of the greeting card flag of FIG. 28A.

FIG. 29A is a view of an alternate embodiment of a greeting card flag showing a single panel attached to a flag portion that is a cinch bag.

FIG. 29B is a side view of the greeting card flag of FIG. 29A.

FIG. 30A is a view of an alternate embodiment of a greeting card flag showing a single panel attached to a flag portion that is a mini-flag.

FIG. 30B is a side view of the greeting card flag of FIG. 30A.

FIG. 30C is a view of the greeting card flag of FIG. 30A after being folded into a greeting card configuration, including a mailing envelope into which the greeting card flag may be inserted.

FIG. 31A is a view of an alternate embodiment of a greeting card flag showing a single panel attached to a flag portion that is a mini-flag with a mini-flag hanger.

FIG. 31B is a side view of the greeting card flag of FIG. 31A.

FIG. 31C is a view of the greeting card flag of FIG. 31A after being folded into a greeting card configuration, including a mailing envelope into which the greeting card flag may be inserted.

FIG. 32A is a view of an alternate embodiment of a greeting card flag showing a single panel attached to a flag portion that is a scarf.

FIG. 32B is a side view of the greeting card flag of FIG. 32A.

FIG. 33A is a view of an alternate embodiment of a greeting card flag showing a single panel attached to a flag portion that is an apron.

FIG. 33B is a side view of the greeting card flag of FIG. 33A.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

A number of materials are identified as suitable for various aspects of the greeting card flag. These materials are to be treated as exemplary and are not intended to limit the scope of the claims. Although any methods and materials similar or equivalent to those described herein can also be used in the practice or testing of the present invention, a limited number of the exemplary methods and materials are described herein.

It will be understood by those having ordinary skill in the art that the various shapes, openings, and cavities as described herein may be made through any applicable manufacturing technique or combinations of techniques, such as but not limited to, casting, forging, drawing, turning, welding, cutting, drilling, injecting, reaming, or other techniques, regardless of the terminology used in describing those shapes, openings, apertures, or cavities.

Unless otherwise noted, the drawings of the present application are not necessarily drawn to scale. They demonstrate the basic relationship of the constituent parts, but not necessarily their respective sizes.

It must be noted that as used herein and in the appended claims, the singular forms “a”, “an”, and “the” include plural referents unless the context clearly dictates otherwise. As used herein, the term “nominal surface area” includes the full surface area within the outer boundaries of an element as if that element contained no cutouts or openings.

As used herein, the term “flag” or “flag portion” is used to refer to any element, such as a flag, banner, sign, pennant, or the like, that is suitable for display for decorative or other purposes to convey a message or for aesthetic purposes. As used herein, the term “flag” or “flag portion” may be of any size or shape and may comprise one or more layers. As used herein, the term “flag” or “flag portion” may additionally refer to additional flexible articles not designed to function on their own as a greeting card, including, but not limited to, tea towels, wine bags, and grocery bags. In additional embodiments of the greeting card flag, the flag portion may be a scarf or an apron. Therefore, it is to be noted that in some embodiments, the “flag portion” may refer to and specifically include an item that is not a “flag” in the traditional sense of the word.

As used herein, the term “panel” refers to any piece of material, regardless of shape or size, capable of being removably attached to the flag portion and capable of providing structure and support to the flag portion to allow the flag portion to be folded into a greeting card configuration. It should be noted that a panel may be smaller or larger than the flag portion to which it is attached. A panel may be comprised one or more of a number of materials, including, but not limited to, paper, cardboard, corrugated fiberboard, plastics, seed paper, polyvinyl chloride (PVC), resin, polyethylene fibers (such as Tyvek® fibers), and similar materials. When panels are not larger than the flag portion in either width or length and the panels are not attached to one another, they may be referred to as “floating.” When panels are not larger than the flag portion in either width or length and the panels are attached to one another, they may be referred to as “fixed.” When a panel is larger than the flag portion in at least either width or length, the flag portion may be described as “floating.” All three of these implementations are within the scope of the present application and are described below.

As used herein, the term “foldable material” refers to a material that is able to be folded by a user with minimal effort. Examples of such material include paper, cardboard, corrugated fiberboard, seed paper, cloth, polyester, nylon, rayon, or a combination thereof and similar materials.

As used here, the term “panel section” refers to a portion of a panel that may be bounded by one or more folding lines and/or one or more edges of the panel. A single panel may include one and only one panel section that occupies the entire panel. A single panel may also include a plurality of panel sections that each occupies a portion of the entire panel. A folding line may intersect a single panel section in some embodiments. Often, by folding panel sections onto adjacent panel sections, any flag portion attached to the two panel sections would necessarily be folded along the folding line or edges between the two panel sections, thus facilitating even and structured folding of the flag portion.

As used herein, the term “greeting card” refers to an article that includes one or more panels (typically four) that includes a greeting or message for the intended recipient of the card.

Greeting Card Flag

Disclosed herein is a greeting card flag that incorporates various aspects of greetings cards and decorative flags in a new manner.

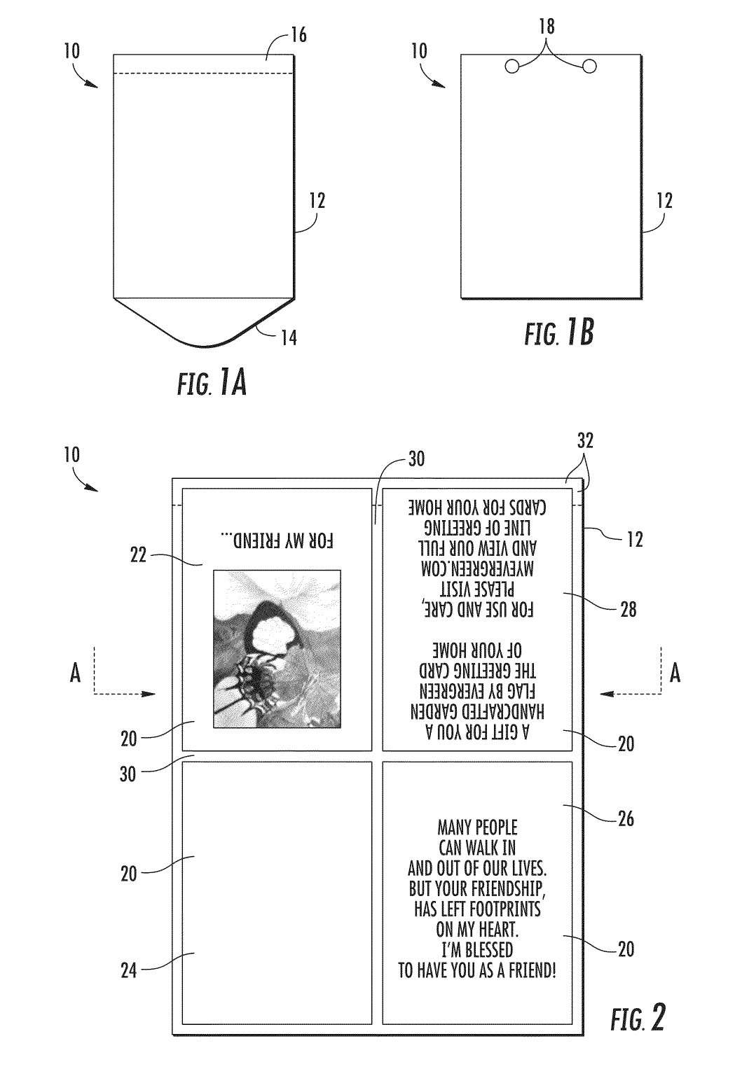

Referring to FIG. 1, an embodiment of the greeting card flag 10 is shown including a flag portion 12 made of a suitable material. Such suitable materials may include, but are not limited to, various fabrics and cloths, polyester, cotton, rayon, nylon, and polyethylene fiber products (such as Tyvek® fibers). The flag portion 12 may have a generally rectangular shape and may have additional contour embellishments 14 such as cutouts or sewn-on pieces in order to give the flag a non-rectangular contour. As shown in FIG. 1A, the flag portion 12 may include a support pocket 16 capable of receiving a flag support. The support pocket 16 may be a sleeve or loop of flag material or may be sown or attached separately to the flag portion 12. The flag support (not shown) may be any device capable of supporting the flag in a display configuration, including, but not limited to, a flag pole, a flag bracket, a flag dowel, or one or more hooks. The flag support may be inserted into the support pocket 16 when the flag is to be displayed. In an embodiment shown in FIG. 1B, in addition to or instead of a support pocket, the flag portion 12 may include one or more openings 18 allowing the flag portion 12 to be hung in a display configuration, from a device such as a hook or nail.

As shown in FIGS. 1A, 1B, and 2, it is understood that the flag portions 12 are depicted as horizontally symmetric and without designs, patterns, or other embellishments. It will be appreciated by one having ordinary skill in the art that in actual use, the flag portion 12 may include designs, patterns, and other embellishments and may be asymmetrical in shape.

Referring to FIG. 2, the greeting card flag 10 may include one or more panels 20 attached in some fashion to the flag portion 12. In an embodiment, the greeting card flag 10 contains four panels 20, specifically a cover panel 22, a left inside panel 24, a right inside panel 26, and a rear panel 28. Each panel 20 provides structure and support to the flag portion 12 such that the greeting card flag 10 may be easily handled and so that the greeting card flag 10 may be folded along pre-defined folding lines 30. As used herein, the term “folding lines” includes the imaginary, generally line-shaped expanses about which the greeting card flag 10 may be folded in order to be manipulated into a folded configuration. The term “folding lines” does not necessarily refer to any actual printed, scored, or otherwise visible lines. In an embodiment, the pre-defined folding lines 30 are formed by leaving gaps between the panels 20 when positioning the panels 20 to the flag portion 12. During production, the panels 20 may be applied to the flag portion 12 in various acceptable manners that leave the appropriate spacing between the panels.

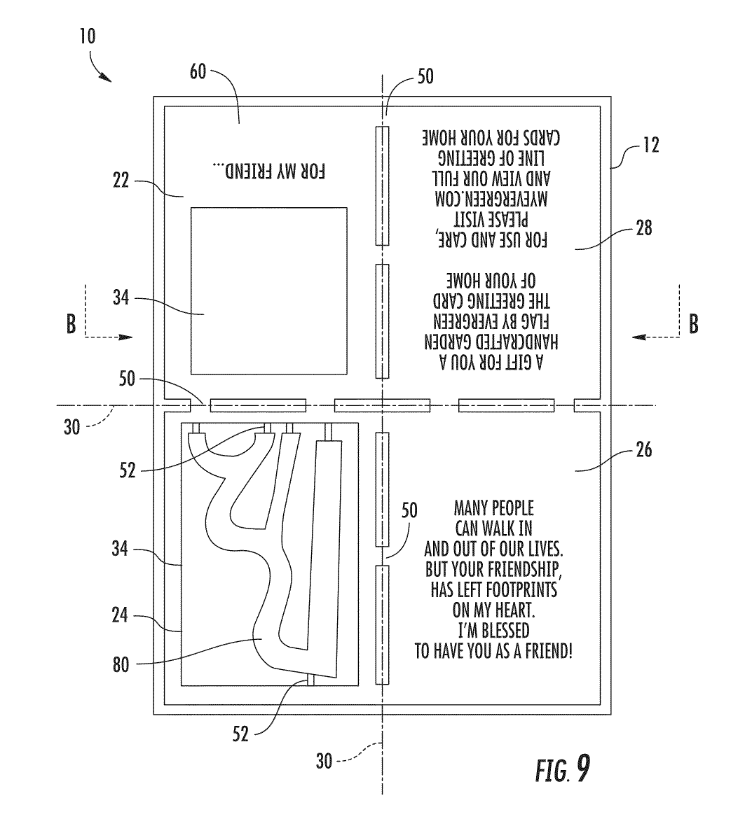

Each panel 20 may encompass approximately slightly less than one quarter of the nominal surface area of one side of the flag portion 12. In such embodiments, the flag portion 12 may include four panels arranged thereon such that there is space between the panels 20 and between the panels 20 and any outside edges of the flag portion 12. The flag portion 12 can then be folded along the space between the panels 20. In some embodiments, each panel 20 may encompass approximately one quarter of the nominal surface area of one side of the flag portion 12 minus one or more small border areas 32. Additionally, referring to FIGS. 9-10, one or more of the panels 20 may contain a viewing window 34 designed so that the flag portion 12 may be seen through the panel 20. In some embodiments, the viewing window 34 may simply be a cutout formed in the panel itself 20. In some embodiments, the viewing window 34 may include a window cover 36 of transparent, translucent, or opaque material. The window cover 36 may be secured to the panel 20 in various manners, such as adhesive, glue, hook and loop and others. In some embodiments, the window cover 36 may be secured to the panel 20 on only one side, allowing the window cover 36 to open as if hinged on the side secured to the panel 20. In some embodiments, the viewing window 34 may occupy substantially all of the panel 20.

As shown in FIG. 2, each panel 20 may optionally carry a message. As used herein, the term “message” refers to any combination of text, graphics, or other material printed on or otherwise affixed to the panel 20.

While FIG. 2 shows an implementation of the greeting card flag 10 having four panels 20, it should be understood that the greeting card flag 10 may be implemented with any number of panels 20 removably attached thereto. For example, greeting card flag 10 may include one, two, three, four, six, eight, or more panels as desired. The greeting card flag 10 is not limited to the number of panels 20 that can be removably attached thereto.

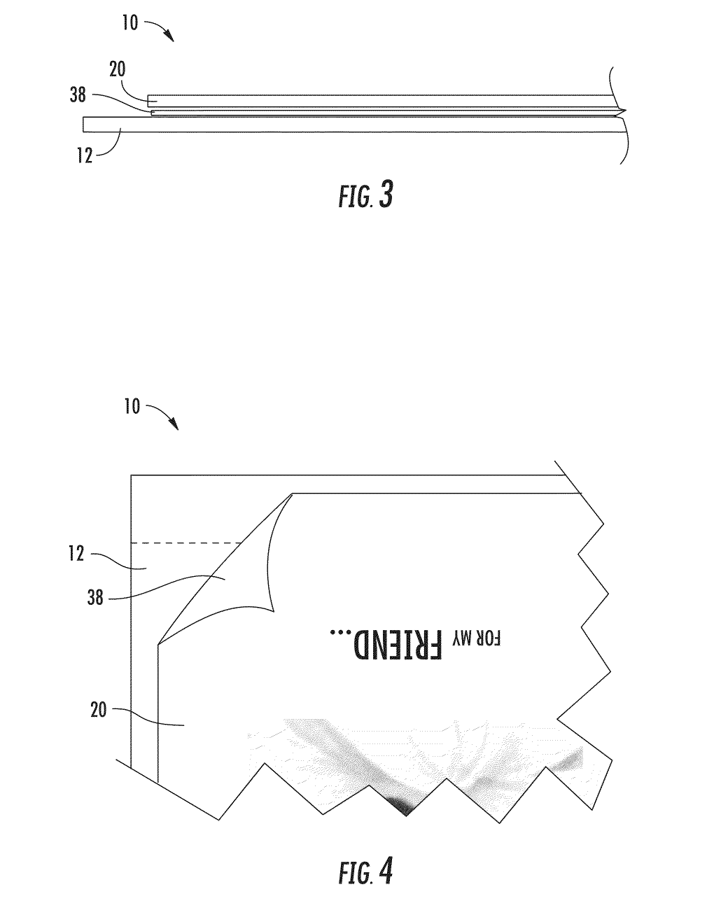

Referring to FIGS. 3-4, each panel 20 may be removably attached to the flag portion 12 such that when any panel(s) 20 are removed from the flag portion 12, the flag portion 12 may be displayed as any other decorative flag, preferably without any remnants or residue (such as from glue or adhesive) from any panel 20. In some embodiments, each panel 20 may contain an adhesive layer 38 capable of removably attaching the panel 20 to the flag portion 12. The adhesive layer 38 may be of any size up to and including the size of the contact area between the panel 20 and the flag portion 12, and any portion thereof. The adhesive layer 38 may be either continuous or discontinuous (e.g., a series of adhesive dots placed at the corners of the contact area between the panel 20 and the flag portion 12). Each panel 20 may be removably attached to the flag portion 12 using any combination of one or more appropriate attachment methods, including, but not limited to, adhesive layers (e.g, dry mount spray, removable tapes, glue dots, and other adhesives), magnetic attraction, snaps, clasps, hook and loop connectors (e.g., Velcro® fasteners), friction hold (e.g., via placing the flag portion 12 through or around one or more notches, tabs, or slits in the one or more panels 20), rubber bands, ribbons, strings of yarn, or removable stitching. In other words, the attachment of the panel 20 to the flag portion 12 is not limited. In some embodiments, the panels 20 may be attached to the flag portion using a dissolvable connector, such as dissolvable stitching, dissolvable adhesive, or a dissolvable intermediary panel. Such a dissolvable connector may be dissolvable in water. In such an embodiment, the panels 20 may be removable from the flag portion 12 by introducing water to the greeting card flag 10.

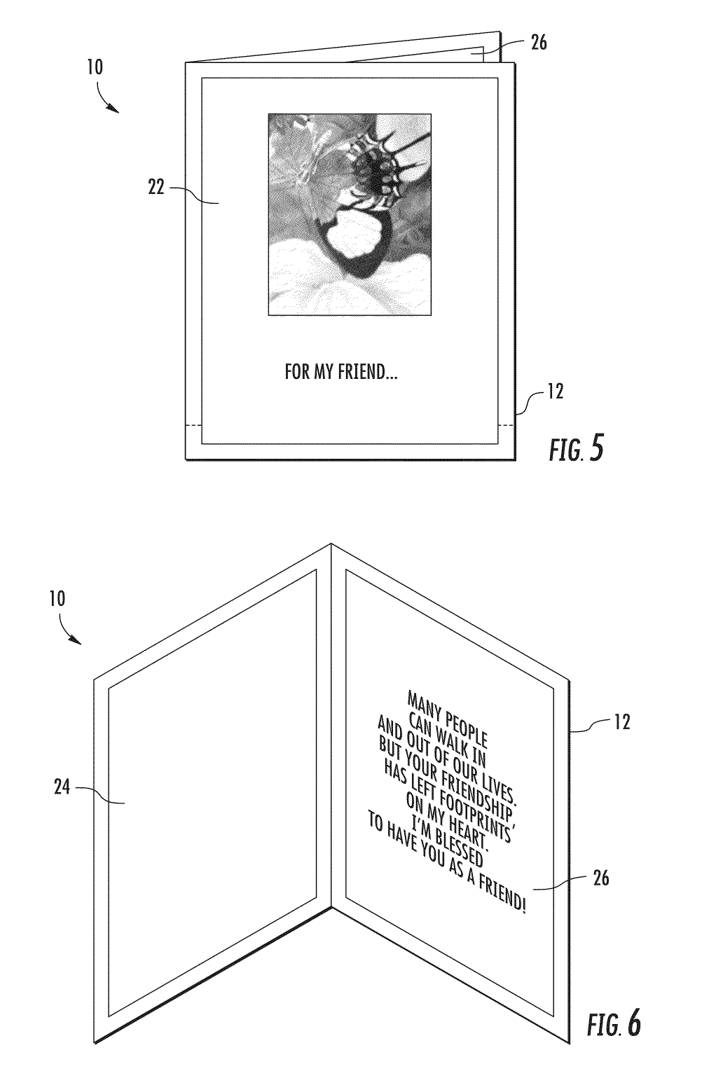

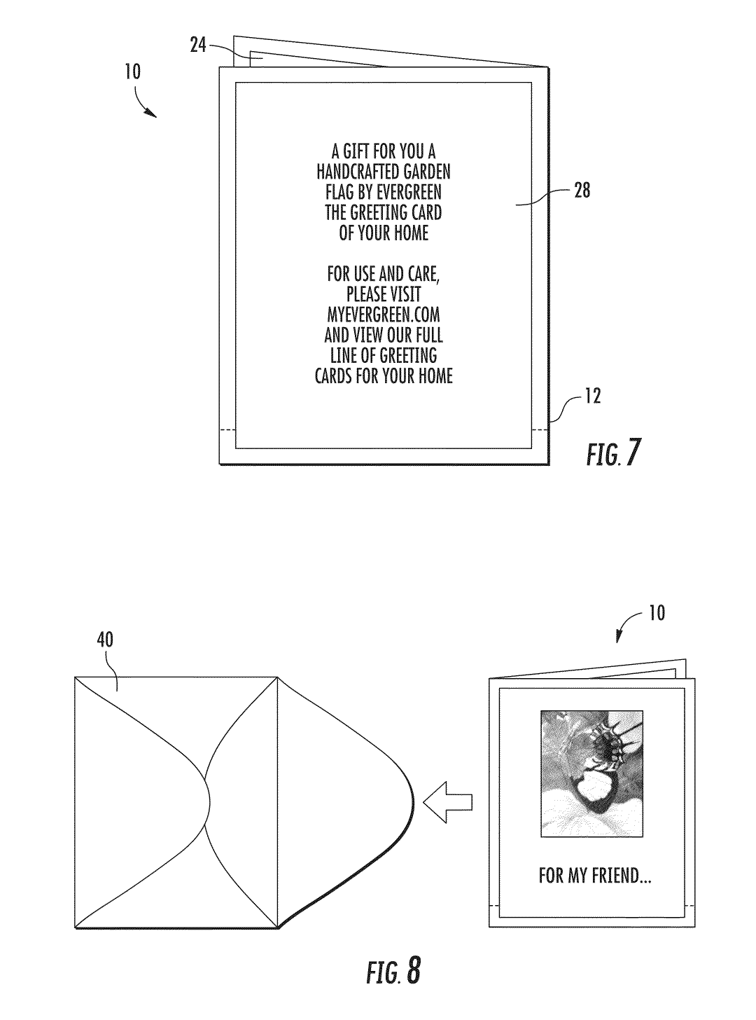

As shown in FIGS. 5-7, the greeting card flag 10 can be folded into a folded configuration by folding the flag portion 12 about the pre-defined folding lines 30. In a folded configuration, the panels 20 act similar to pages of a standard greeting card. In a greeting card configuration, the cover panel 22 and the rear panel 28 act as a standard greeting card's front and back pages, while the left inner panel 24 and the right inner panel 26 act as a standard greeting card's inside pages. Referring to FIG. 8, in a greeting card configuration, the greeting card flag 10 may be inserted into a mailing envelope 40. A standard mailing envelope is generally up to about 7 inches on the longest side. In some embodiments, the mailing envelope may be up to 9 inches in length. In some embodiments, the mailing envelope may be larger. As used herein, the terms “mailing envelope” or “envelope” includes envelopes configured to be mailed or delivered to a recipient, including examples such as envelopes sent by post and envelopes attached to hand-delivered gifts. In a greeting card configuration, the greeting card flag 10 may be mailed or delivered to a recipient in a manner similar to mailing or delivering a standard greeting card.

In certain embodiments, the flag portion 12 is positioned between the greeting card panels 20 such that the flag portion 12 is not readily visible when the greeting card flag 10 is in a greeting card configuration. The greeting card flag 10 may then be delivered without an envelope 40 or in an envelope 40 made of transparent or translucent material without signaling to the recipient what is contained within the greeting card flag 10 until the greeting card flag 10 is opened.

As used herein, the term “greeting card configuration” refers to a configuration wherein the greeting card flag is folded into a shape that resembles a greeting card. The greeting card configuration is not limited to a shape that resembles a greeting card having a front panel, two inside panels, and a rear panel, but also includes shapes resembling greeting cards having fewer or more panels, such as a single-page greeting card or a tri-fold greeting card.

In an embodiment, when so desired, such as upon receipt, the greeting card flag 10 presented in a greeting card configuration, may be unfolded and any panels 20 may be removed from the flag portion 12.

Referring to FIG. 9, the greeting card flag 10 may include a plurality of panels 20 joined together by panel connectors 50. These panel connectors 50 provide additional support and allow the plurality of panels 20 to be removed from the flag portion 12 together without changing their relative position to one another. Additionally, the panel connectors 50 may contain scoring, creases, flexible portions, or hinges that may assist in manipulating the greeting card flag 10 into a folded configuration by folding the greeting card flag 10 along the folding lines 30. The panel connectors 50 may be of any applicable size and shape. The panel connectors 50 may be separate pieces of material or may be contiguous pieces of the panel material. In the embodiment shown in FIG. 9, the panel connectors 50 are contiguous pieces of panel material such that the four panels 22, 24, 26, 28 present in the embodiment shown are constructed from a single piece of material. In other words, for example, the panels 22, 24, 26, 28 and panel connectors 50 shown in FIG. 9 may be created from a single piece of cardstock by cutting out certain portions of the cardstock to make the shape of the four panels 22, 24, 26, 28 and the panel connectors 50. In such an embodiment with panel connectors 50 that are contiguous pieces of panel material and depending upon the context, the term “panel” may refer individually to each panel 22, 24, 26, 28 or may refer to the entire section incorporating all panels 22, 24, 26, 28 and their panel connectors 50. In other words, the embodiment shown in FIG. 9 may also be described as having a single panel with cutouts.

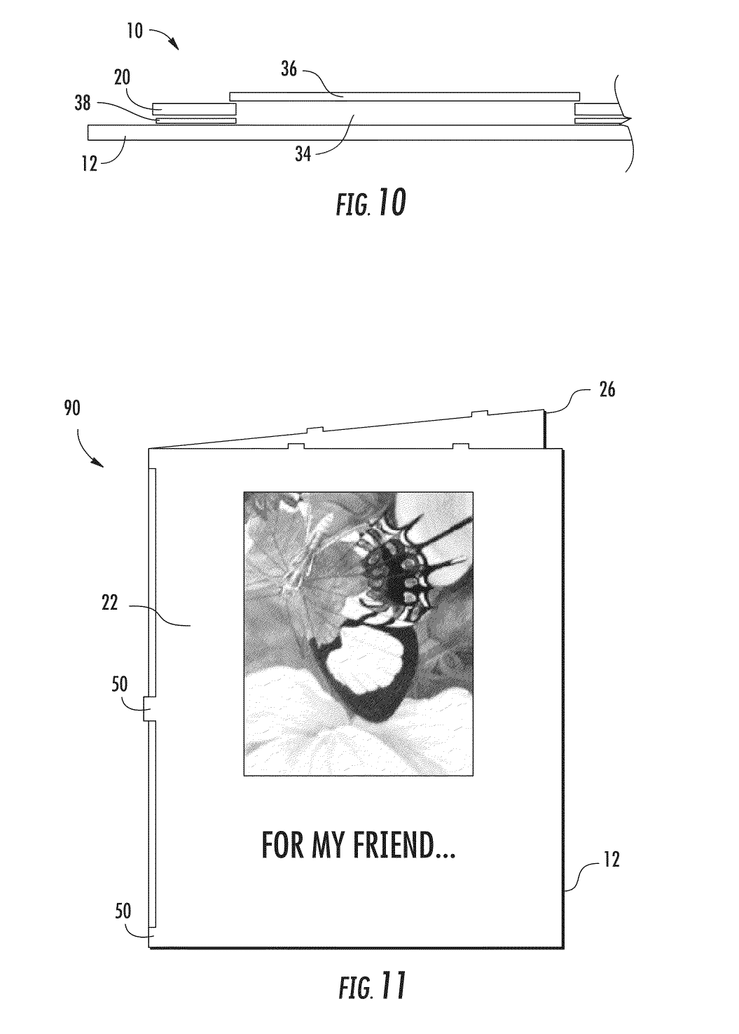

Referring to FIGS. 9, 11, and 14, when the plurality of panels 20 having panel connectors 50 is removed from the flag portion 12, each individual panel 20 will maintain its position relative to the remaining panels 20 because of the presence of the panel connectors 50. As shown in FIG. 11, once removed from the flag portion 12, the panels 20 with panel connectors 50 can be folded again along the folding lines 30 such that the bottom sides 70 of each of the plurality of panels 20 touches and/or aligns with the bottom sides 70 of another of the plurality of panels 20. In this fashion, once removed from the flag portion 12, the plurality of panels 20 can be easily re-folded into the greeting card configuration 90 and the panels 20 will act similar to pages of a standard greeting card. Thusly, a recipient is able to separate the flag portion 12 from the greeting card flag 10 for use as a decorative flag while additionally keeping the plurality of panels 20 in a greeting card configuration 90 for use as a standard greeting card.

As shown in FIG. 14, a greeting card flag 10 is present in an envelope 40. Once removed from the envelope 40 and read, the greeting card flag 10 may be opened and the panels 20 may be removed. Once the panels 20 have been removed, the panels 20 may be folded into a greeting card configuration 90 while the flag portion 12 may be displayed. In the embodiment shown in FIG. 14, the greeting card flag 10 includes a flag hanger 80, described below, to permit the flag portion 12 to be displayed by hanging from a hook 92 while the greeting card configuration 90 is displayed on a mantel 91. Of course, flag portion 12 may be displayed by hanging from flag supports, described above, and the greeting card configuration 90 may be displayed on other surfaces or in other manners than on a mantel 91.

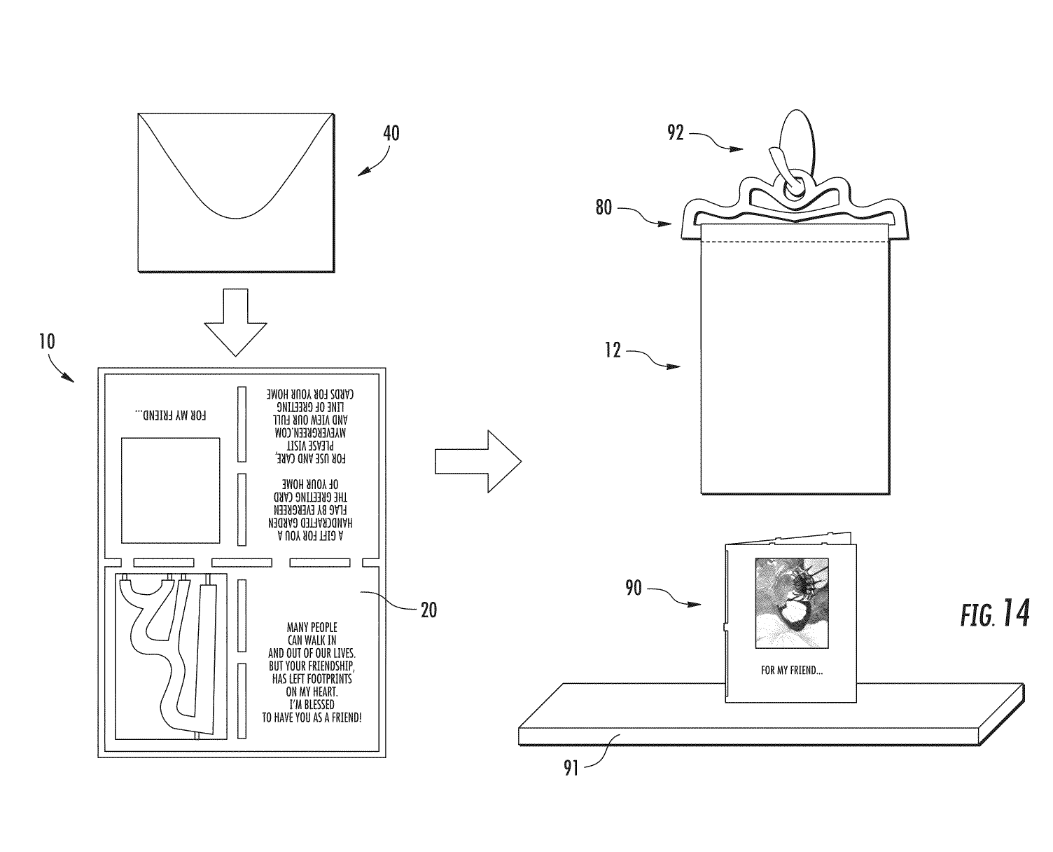

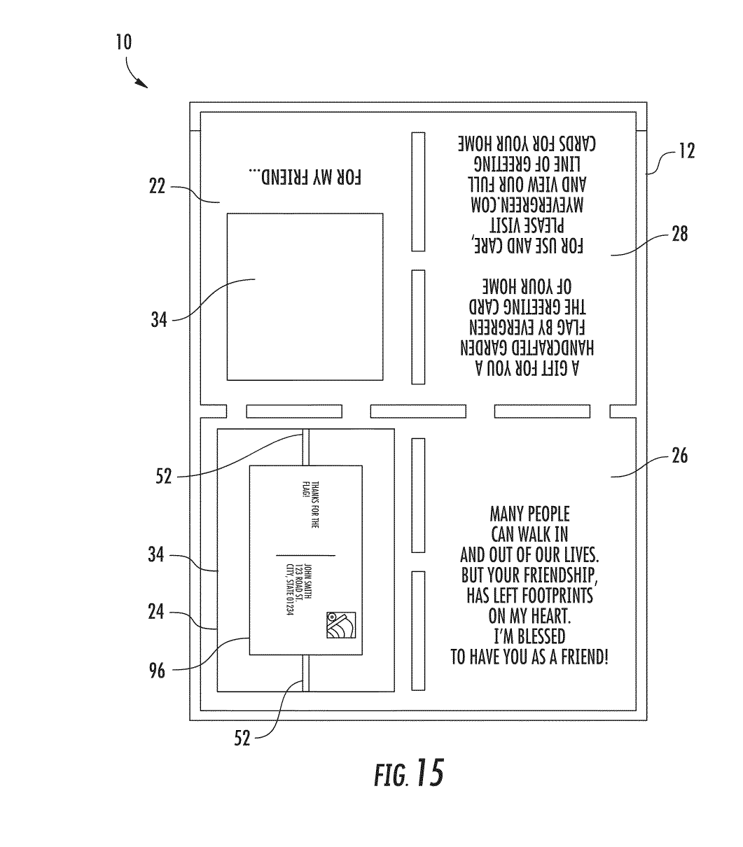

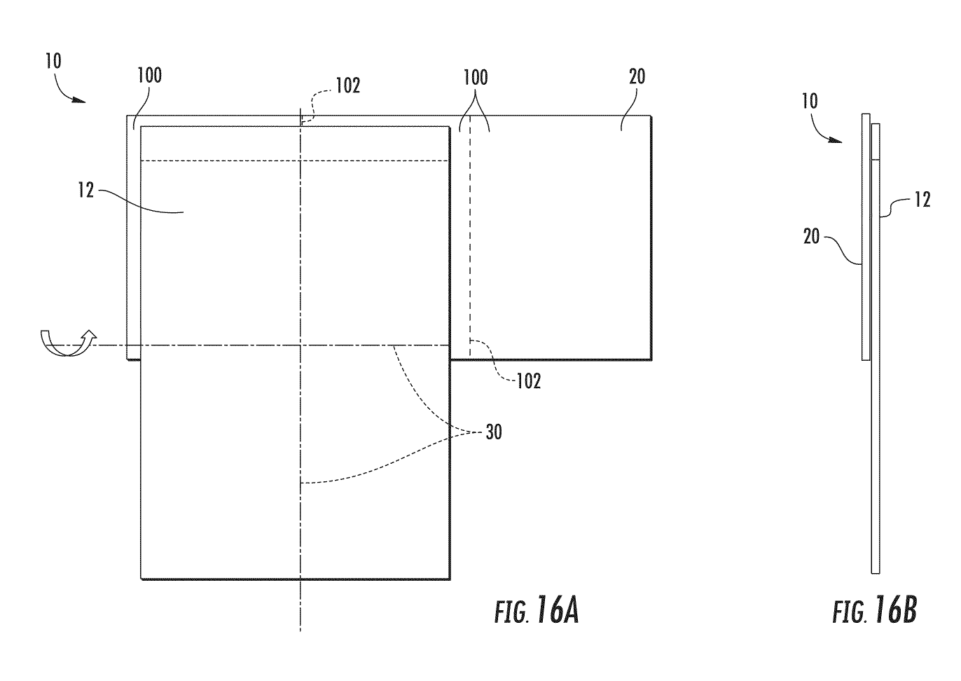

Referring to FIGS. 16A-17C, a greeting card flag 10 may include a single panel 20 having one or more panel sections 100. For example, a panel 20 may contain 2, 3, 4, 6, or more panel sections 100 as desired. The panel 20 may include one or more scored or creased portions 102, one or more of which may act as folding lines 30. It will be understood that adhesive layer 38 is present in FIGS. 16B and 17B, but not discernible or labeled. In the embodiment shown in FIGS. 16A-17C, folding the panel sections 100 along the scored or creased portions 102 may be used to assist in folding the flag portion along folding lines 30. However, the flag portion may be folded along folding lines 30 without the use of the panel sections 100 or the scored or creased portions 102. The panel sections 100 may be folded together to form a greeting card configuration as shown in FIG. 17C, which may be then inserted into an envelope.

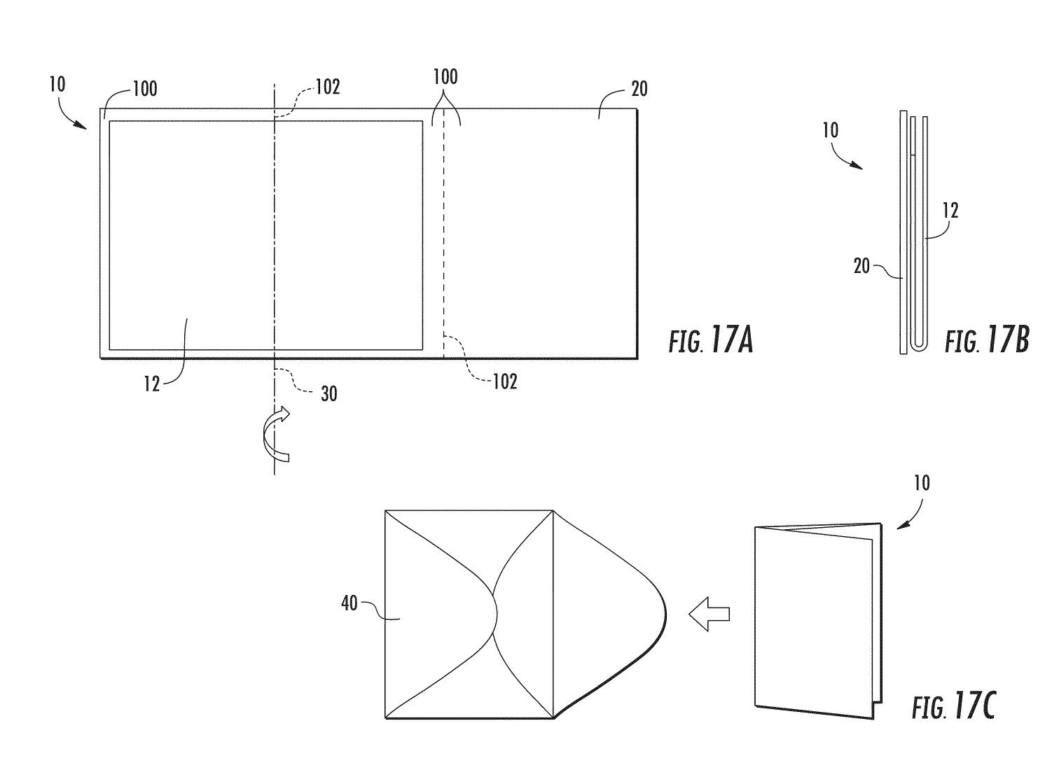

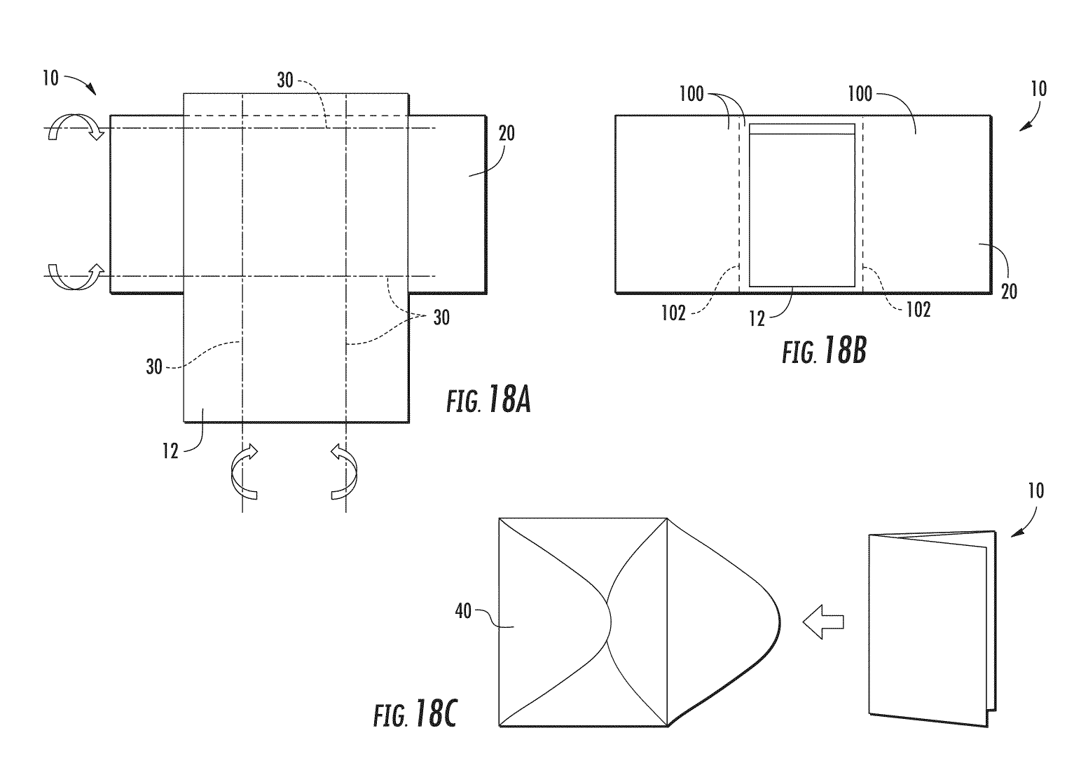

FIGS. 18A-18C show an embodiment of a greeting card flag 10 including a single panel 20 having one or more panel sections 100. This embodiment includes a flag portion 12 located in a certain position across the creased portions 102 of several panel sections 100. The flag portion 12 may be located in any desired location with respect to panel 20; i.e., the flag portion 12 may float with respect to the panel 20. The flag portion 12 of this embodiment may be folded onto itself several times as shown in FIG. 18b, before the greeting card flag 10 is folded into a greeting card configuration, as shown in FIG. 18c, which may then be inserted into an envelope 40.

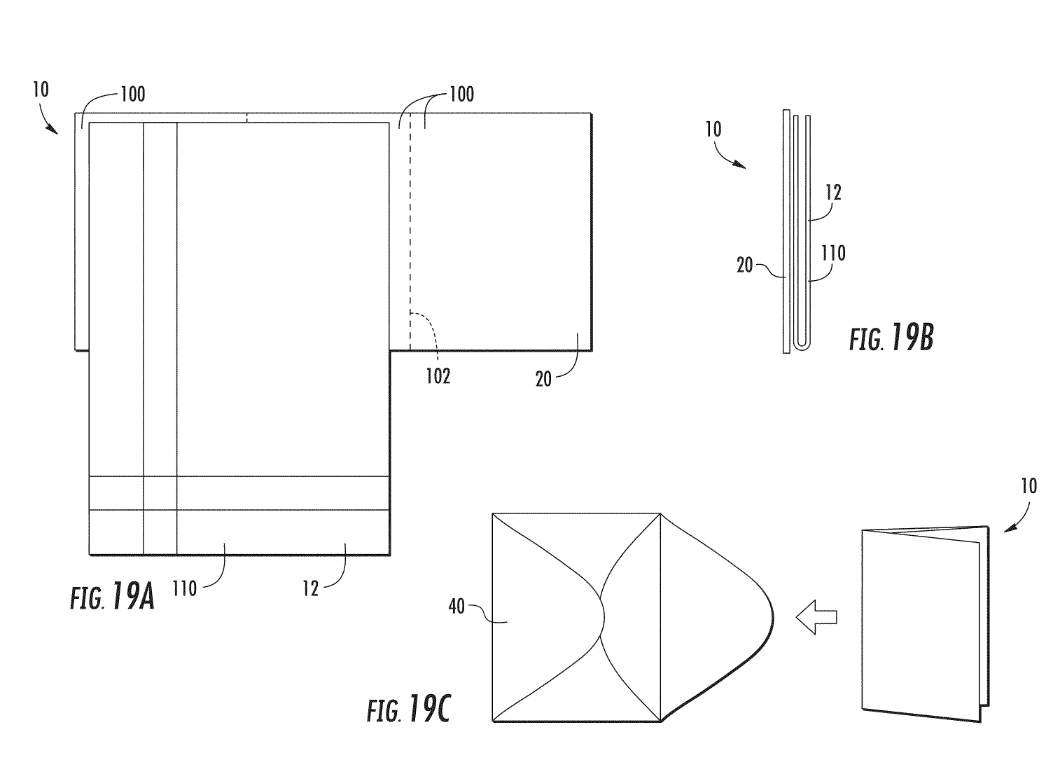

FIGS. 19A-19C show an embodiment of a greeting card flag 10 including a single panel 20 having one or more panel sections 100. This embodiment shows a flag portion 12 that is a tea towel 110. The flag portion 12 that is a tea towel 110 may be folded similarly to the flag portion of FIGS. 16A-17C. Referring back to FIGS. 19A-19C, the greeting card flag 10 containing the tea towel 110 may be folded into a greeting card configuration and may be inserted into an envelope 40.

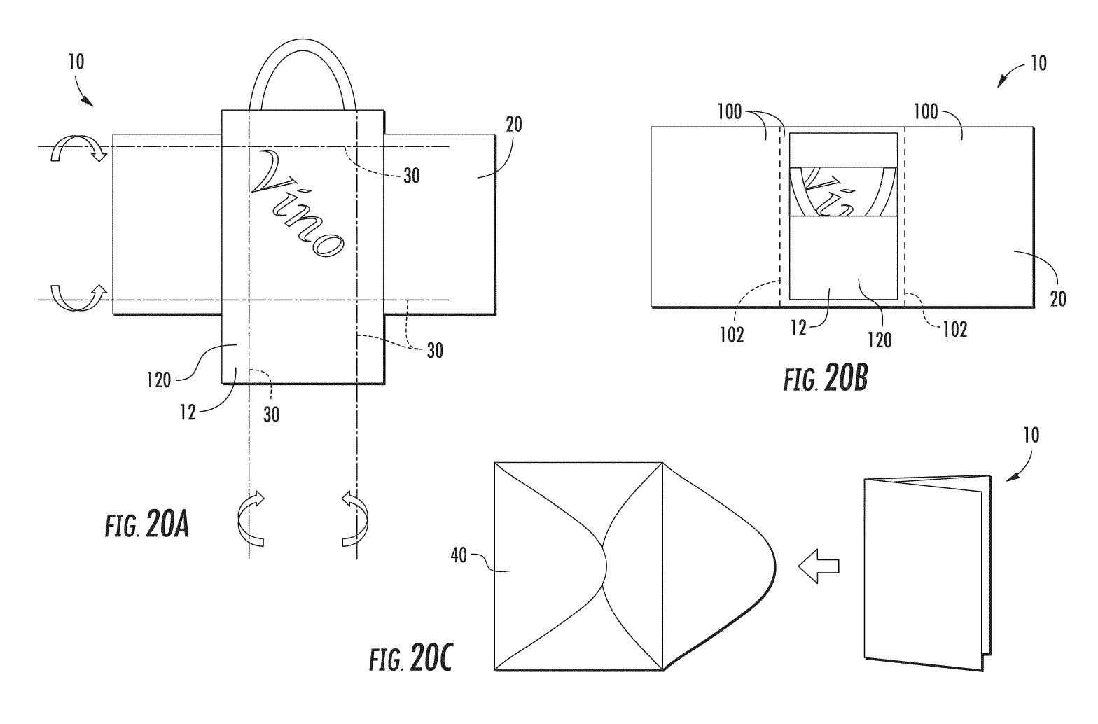

FIGS. 20A-20C show an embodiment of a greeting card flag 10 including a single panel 20 having one or more panel sections 100. This embodiment shows a flag portion 12 that is a wine bag 120. The flag portion 12 that is a wine bag 120 may be folded similarly to the flag portion of FIGS. 18A-18C. Referring back to FIGS. 20A-20C, the greeting card flag 10 containing the wine bag 120 may be folded into a greeting card configuration and may be inserted into an envelope 40.

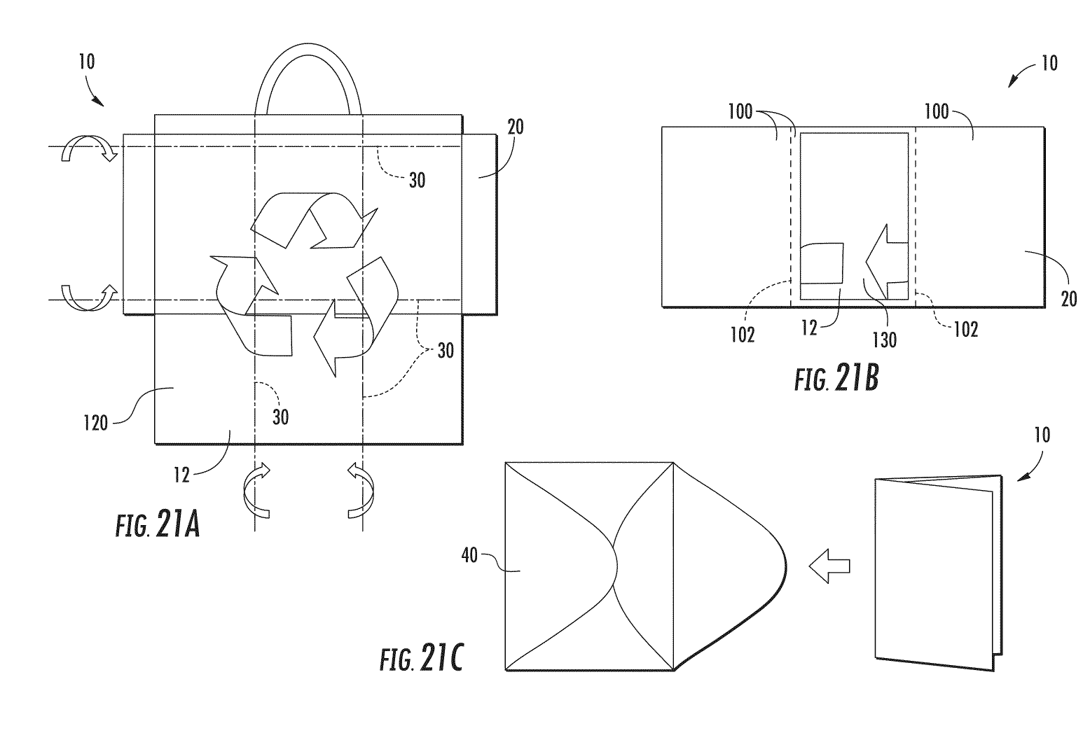

FIGS. 21A-21C show an embodiment of a greeting card flag 10 including a single panel 20 having one or more panel sections 100. This embodiment shows a flag portion 12 that is a grocery bag 130. The flag portion 12 that is a grocery bag 130 may be folded similarly to the flag portion of FIGS. 18A-18C. Referring back to FIGS. 21A-21C, the greeting card flag 10 containing the grocery bag 130 may be folded into a greeting card configuration and may be inserted into an envelope 40.

In some embodiments not shown, a greeting card flag 10 with a plurality of panels 20 may include scores or creases on the panels 20 that serve as folding lines 30, instead of the gaps shown in FIGS. 2 and 9.

As shown in FIGS. 16A, 17A, and 19A, the flag portion 12 may be located on the left side of the panel 20. As shown in FIGS. 18A, 20A, and 21A, the flag portion 12 may be located near the center of the panel 20. The flag portion 12 may also be located on or near any other portion of the panel 20, including, but not limited to, the right side, the top side, or the bottom side. In other words, there is no limitation as to the location or position of the flag portion 12 with respect to the panel 20.

Flag Hanger

As shown in FIG. 9, a flag hanger 80 may be included with the greeting card flag 10. The flag hanger 80 may be made from any material suitable for providing support to a flag, including, but not limited to, paper, plastic, and metal. The flag hanger 80 may be foldable such that it can be positioned in both an open configuration and a folded configuration. In some embodiments, the flag hanger 80 is removably attached to one of the plurality of panels 20, such as by perforations. The flag hanger 80 may be attached to a panel 20 in various ways, including, but not limited to, adhesives or break-away tabs 52. As used herein, the term break-away tabs includes any extra material including, but not limited to, the extra material of a panel 20 and extra material of the flag hanger 80, which is designed to be broken or removed in order to separate the flag hanger 80 from the panel 20. In some embodiments, the flag hanger 80 may have extra material that forms a break-away tab which itself is removably or permanently secured to the panel 20. In such an embodiment, the break-away tab can be broken in order to separate the flag hanger 80 from the panel 20. In some embodiments, the panel 20 may include extra material that forms a break-away tab removably or permanently secured to the flag hanger 80. In such an embodiment, the break-away tab can be broken or removed in order to separate the flag hanger 80 from the panel 20. In some embodiments, the flag hanger 80 is positioned within a viewing window 34 of a panel 20. In this fashion, a flag hanger 80 may be included with the greeting card flag 10.

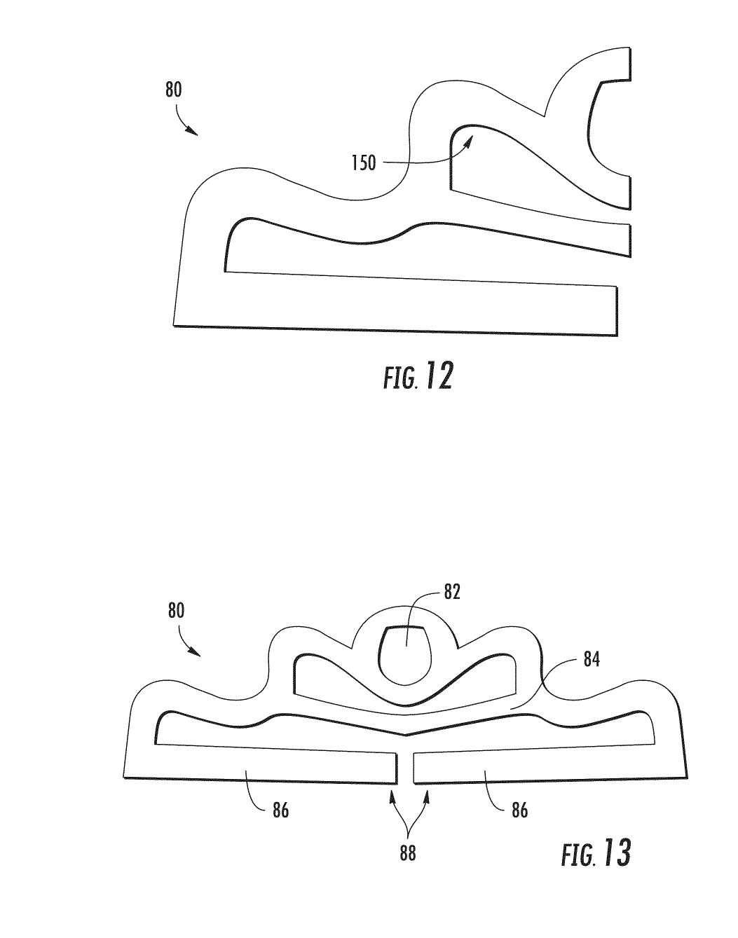

Referring to FIG. 12, a flag hanger 80 is shown in a folded configuration. In a folded configuration, the flag hanger 80 may be better suited for inclusion with the remainder of the greeting card flag 10, such as when delivered in an envelope 40. The flag hanger 80 may be made of any suitable material capable of supporting the flag portion 12 in a display configuration. Further, the flag hanger 80 may be made of a suitable material for folding. In some embodiments, the flag hanger 80 may include one or more hinges or foldable portions in order to provide additional flexibility for manipulating the flag hanger 80 between a folded configuration and an unfolded configuration. Such a foldable portion may include a strip of pliable paper or plastic which can be used to connect two portions of the flag hanger 80 together and allow them to fold.

The flag hanger 80 may be made of two portions that are provided separately and instead of unfolding, can be placed adjacent to one another and connected together. Such a connection may include, but is not limited to, adhesives, friction fits, or other physical or chemical connections. As used herein, any reference to the flag hanger 80 folding or being in an unfolded or folded configuration shall include a flag hanger 80 in which two portions are provided separately and connected together. Therefore, a flag being in a folded configuration may include a flag hanger 80 of a plurality of portions wherein the portions are not connected together, and a flag being in an unfolded configuration may include a flag hanger 80 of a plurality of portion wherein the portions are connected together.

Referring to FIG. 13, the flag hanger 80 may incorporate a shape having a primary hanging point 82, a first strut 84, and one or more hanger struts 86. The primary hanging point 82 may be a circular opening or any other shape suitable for hanging the flag hanger 80. The primary hanging point 82 may be configured to be supported by a hook, nail, doorknob, or other object. The primary hanging point 82 may include a retention mechanism, such as an adhesive layer, capable of attaching the flag hanger 80 to a surface or object. For example, the primary hanging point 82 may be a surface area of the flag hanger 80 treated with an adhesive layer with a removable protective backing. In this example, a flag may be displayed by removing the removable protective backing to expose the adhesive layer of the primary hanging point 82, and pressing the primary hanging point 82 against a flat surface, such as a wall. In another example, the primary hanging point 82 may include a magnet and the method of hanging a flag may include placing the primary hanging point 82 against a surface to which the magnet is attracted. The term “hanging point,” as used herein, includes supporting devices that support the object containing the hanging point at a single point, as well as supporting devices that support the object containing the hanging point at multiple, contiguous or non-contiguous points. For example, it is contemplated that a “hanging point” may include a line of adhesive or a line of magnets located on a flag hanger 80 that may be used to removably or permanently attach the hanger section to another surface. The term “hanging point” may also refer to a series of two or more holes that are located distant from each other through which hooks, nails, or other objects may be passed in order to support the object containing the hanging point. The flag hanger 80 may optionally contain a first strut 84 which provides additional support for the flag hanger 80. The one or more hanger struts 86 are configured to fit within the support pocket 16 of the flag portion 12. The one or more hanger struts 86 may contain securing elements designed to secure the hanger struts 86 to at least one of either another hanger strut 86 or another portion of the flag hanger 80. By securing the hanger strut 86, the flag portion 12 may be kept from falling off. In an embodiment not shown, the securing elements may include, but are not limited to, snaps, clasps, magnets, or hook and loop connectors. The flag hanger 80 may include additional portions or pieces for placement with panel 20 that may be perforated or otherwise easily detached to form the desired flag hanger 80 shape. This may ease manufacturing of the greeting card flag 10.

As shown in FIG. 13, the flag hanger 80 may contain two opposing hanger struts 86 having separate, inward-facing, adjacent, distal ends 88, onto which the support pocket 16 of the flag portion 12 may be positioned.

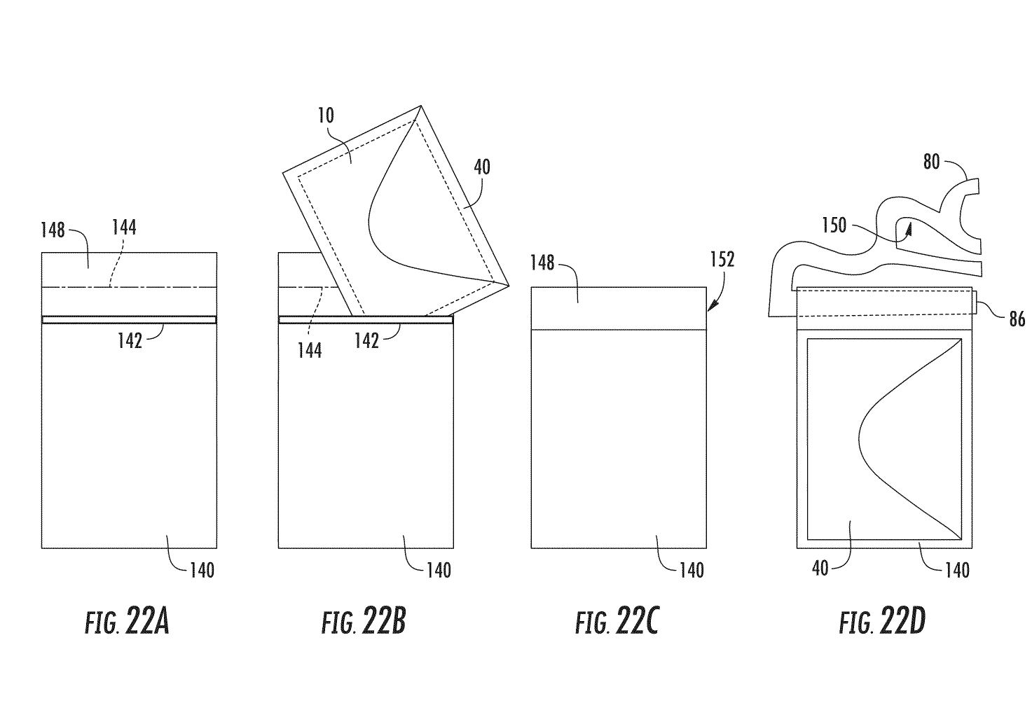

Referring to FIGS. 22A-22D, a point-of-sale container 140 is shown. The point-of-sale container 140 may be transparent, translucent, or opaque. The point-of-sale container 140 may contain a pocket 142, a crease 144, and a flap 148. As shown in FIG. 22B, an envelope 40 containing a greeting card flag 10 (shown in dashed lines) may be inserted into the pocket 142. FIG. 22C shows a point-of-sale container 140 with the flap 148 folded over the crease 144. The flap 148 or the point-of-sale container 140 may include adhesive or other retention mechanism, or external adhesive or other retention mechanism may be applied, to secure the flap 148 in a secured configuration. The term “secured configuration” shall include any combination of the flap 148 being secured to a portion of the point-of-sale container or being secured in relation to a portion of the point-of-sale container. As shown in FIG. 22D with reference also to FIG. 22A, one or more hanger struts 86 of the flag hanger 80, when in a folded configuration, may be inserted between the crease 144 and the pocket 142 such that the flag hanger 80 can be used to support the point-of-sale container 140. In this fashion, the point-of-sale container 140 may be hung by inserting a flag hanger 80 in the described way and hanging the flag hanger 80 by a secondary hanging point 150.

As shown and described with reference to FIGS. 22A-22D, the point-of-sale container 140 includes a hanging recess 152 formed by folding the flap 148 along the crease 144 and securing it. The hanging recess 152 is any space into which the one or more hanger struts 86 of the flag hanger 80, when in a folded configuration, may be inserted. The hanging recess 152 may be formed by securing the flap 148, or may be naturally present in the construction of the point-of-sale container 140. The hanging recess 152 may also be formed by applying extra material to the point-of-sale container 140, such as a semi-adhesive material to the back of the point-of-sale container 140.

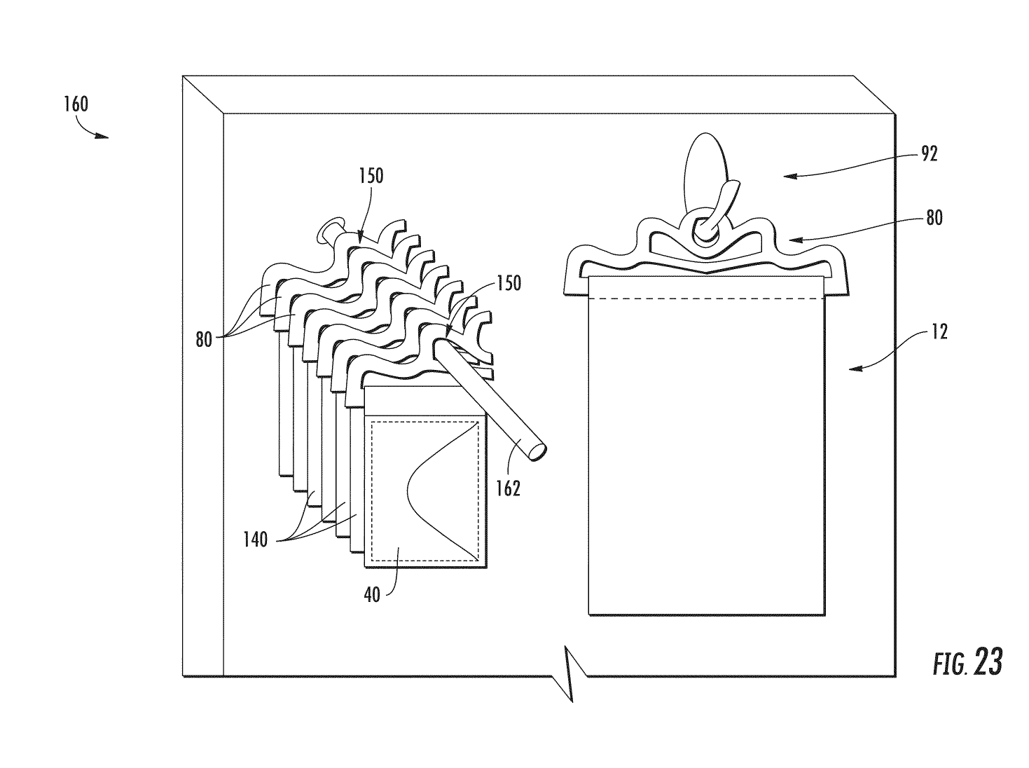

Referring to FIG. 23, a point-of-sale display 160 is shown. A number of point-of-sale containers 140 are hanging from a number of flag hangers 80. The flag hangers 80 are each supported at their secondary hanging points 150 upon a rod 162. The point-of-sale containers 140 may contain one or more envelopes 40, which each may contain one or more greeting card flags 10. FIG. 23 further shows a flag portion 12 supported by a flag hanger 80 presented in an unfolded configuration and hanging by its primary hanging point 82 from a hook 92.

Separable Pieces

In an embodiment, a separable piece 96 may be included with the greeting card flag 10 in some manner. As shown in FIG. 15, a separable piece 96 may be attached to a panel 20 using break-away tabs 52. The separable piece 96 may be attached to the panel 20 using other techniques not shown, including, but not limited to, use of adhesives, use of pockets, use of magnets, or use of dissolvable connectors or layers. The separable piece 96 may be made of any of the materials listed above of which a panel may be made and may include further materials. The separable piece 96 may be made of the same or a different material than any of the other panels 20 included in the greeting card flag 10. In an embodiment, the separable piece 96 may be a postcard capable of being detached and mailed separately from the greeting card flag 10. In an embodiment, the separable piece 96 may be seed paper (i.e., paper containing one or more seeds) capable of being detached and planted in soil. In an embodiment not shown, the separable piece 96 may include a piece of computer readable media. The separable piece 96 may be any other generally flat thing desired to be included with the greeting card flag 10 and be separable from the flag portion 12 and the panels 20.

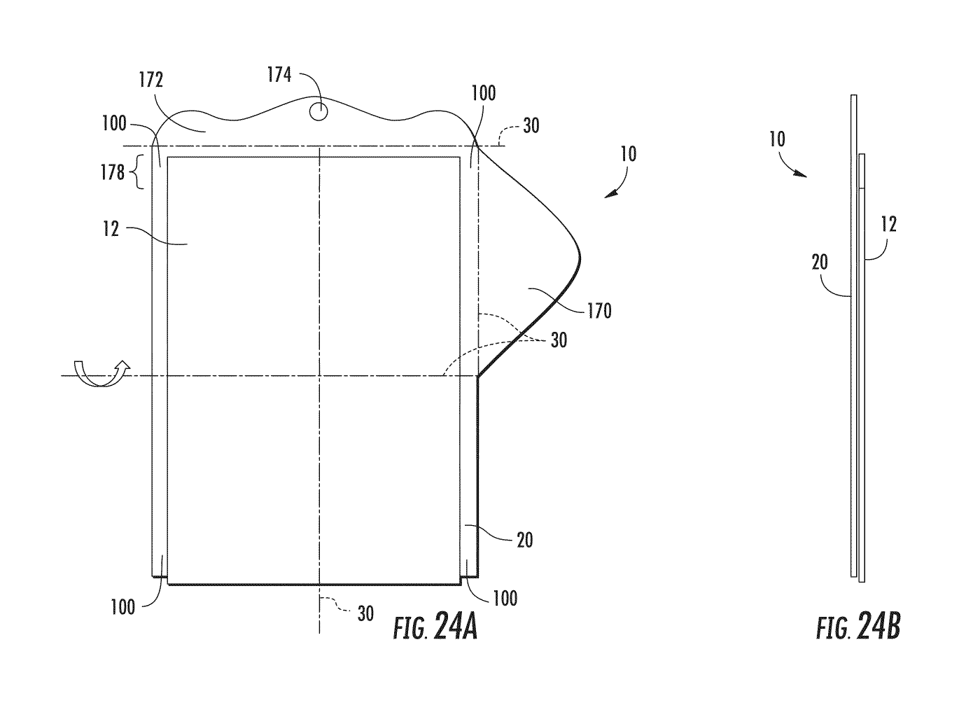

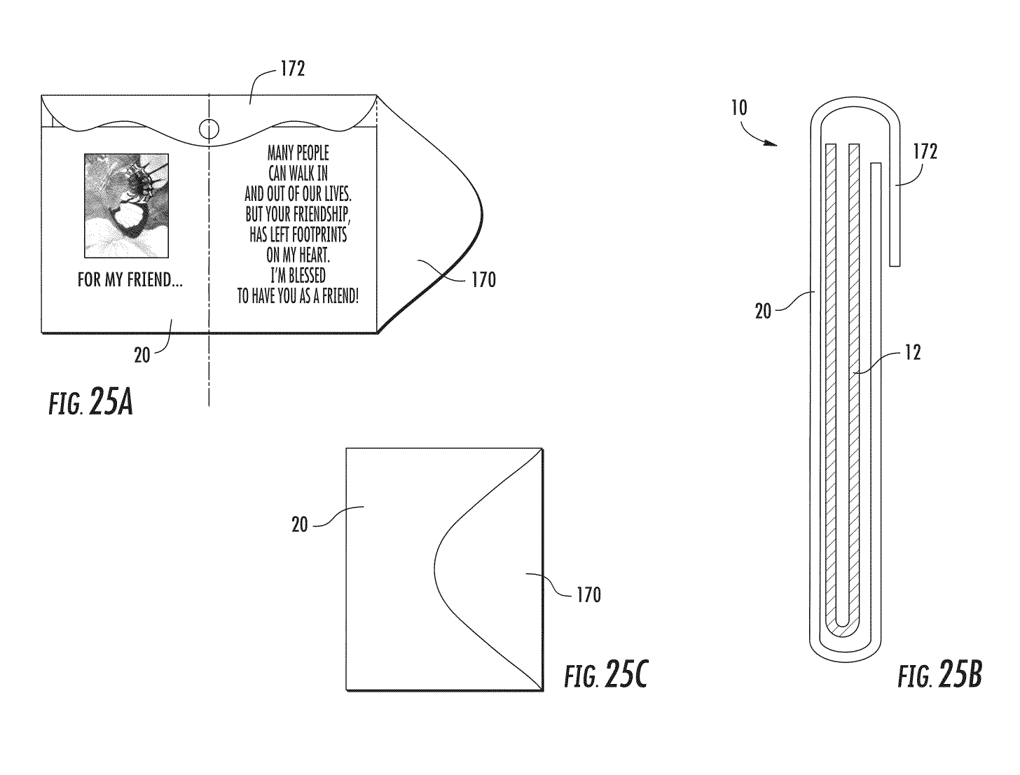

Referring to FIGS. 24A-25C, a greeting card flag 10 is shown. A flag portion 12 is affixed to a panel 20 in any of the ways described above. The flag portion 12 may be affixed to the panel 20 only at a limited number of points, such as only along a top portion 178 of the flag. As shown in FIG. 24A, the panel 20 has four panel sections 100, but the panel 20 may have any number of panel sections 100, including more than or fewer than four. The panel 20 may optionally include an envelope flap 170. The envelope flap 170 may be a separate piece of material attached to the panel 20 or may be part of the panel 20 itself. As shown in FIG. 24A, the envelope flap 170 is part of the panel 20 itself. The panel 20 may additionally include a hanger section 172. The hanger section 172 may be a separate piece of material attached to the panel 20 or may be part of the panel 20 itself. As shown in FIG. 24A, the hanger section 172 is part of the panel 20 itself. The hanger section 172 may include one or more primary hanging points 174 from which the hanger section 172 may be supported, such as on a nail or hook. Folding lines 30 are also shown in FIG. 24A.

As shown in FIGS. 25A-25B, the greeting card flag 10 may be folded into a greeting card configuration. As shown in FIG. 25C, the greeting card flag 10 may be folded into a envelope configuration wherein the envelope flap 170 is folded down onto the remainder of the panel 20. The envelope flap 170 may be secured to the remainder of the panel 20 using any suitable methods such as those described above for affixing the flag portion to the panel 20 or other methods of securing an envelope flap to the remainder of an envelope in a traditional envelope, such as adhesives or postage glue.

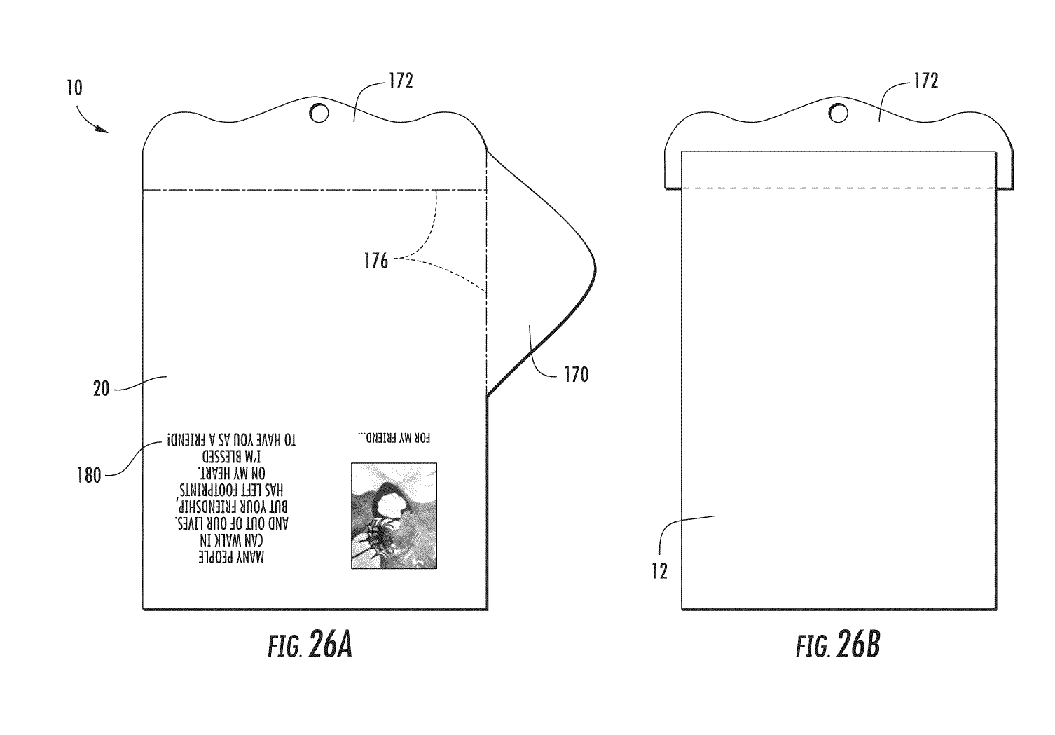

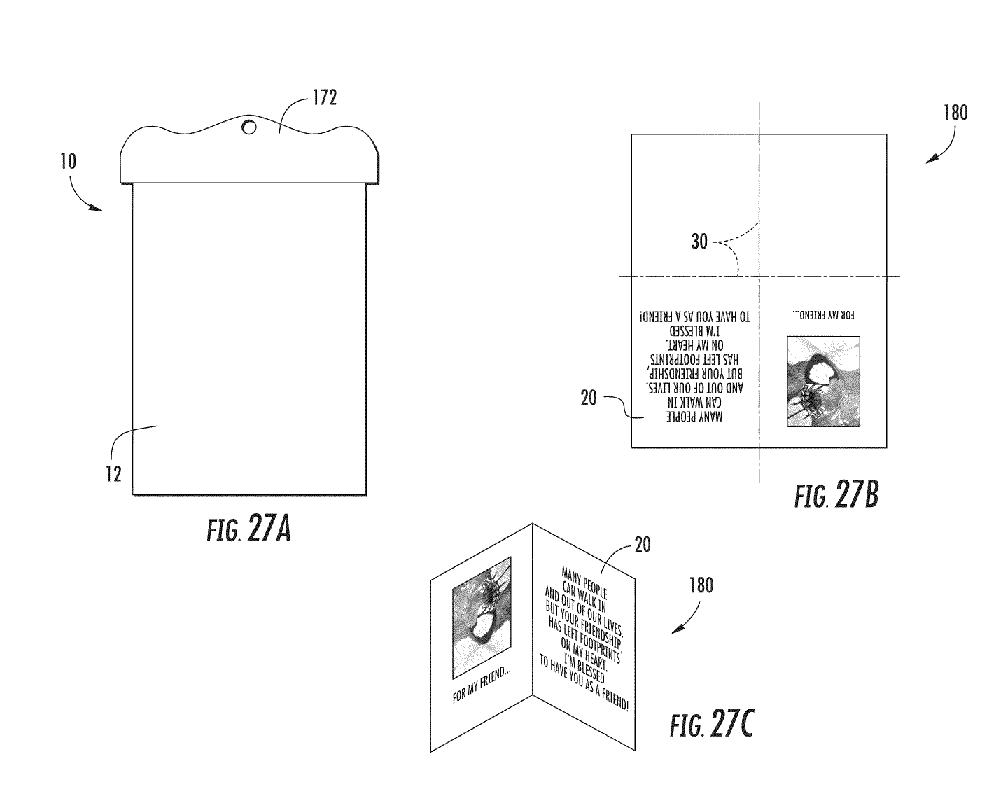

After receiving a greeting card flag 10 as shown in FIGS. 24A-25C, a recipient may unsecure the envelope flap 170 and unfold the greeting card flag 10. FIG. 26A shows the view of the rear of an unfolded greeting card flag 10. The greeting card flag 10 may optionally include one or more separation lines 176. As shown in FIG. 26A, the greeting card flag 10 has two separation lines 176, one located below hanger section 172 and one located between the envelope flap 170 and the remainder section 180 of the panel 20. The separation lines 176 may simply be indicators of where the panel 20 may be cut using an external device such as a pair of scissors. The separation lines 176 may, however, be perforations, creases, or other such treatments to the panel 20 at those areas that allow a user to more easily separate the panel 20 along the separation lines 176. It will be understood that in embodiments where the hanger section 172 and/or the envelope flap 170 are separate pieces removably affixed to the panel 20, the term separation lines 176 is to be read as including the locations where the hanger section 172 and/or the envelope flap 170 are removably attached to the panel 20. In use, the separation lines 176 guide or aide a user in separating one or more of the hanger sections 172 and the envelope flap 170 from the body section 180 of the panel 20. When removing the body section 180 of the panel 20 from the hanger section 172, removal may be easier when the flag portion 12 is affixed only to the hanger section 172, eliminating the need to remove the body section 180 of the panel 20 from the flag portion 12. As shown in FIGS. 27B-27C, the body section 180 of the panel 20 may be retained and may be folded into a body section greeting card configuration. As shown in FIGS. 26B-27A, the flag portion 12 may remain affixed to the hanger section 172. In this fashion, after separation, the hanger section 172 may be used to place the flag portion 12 on display, in a display configuration.

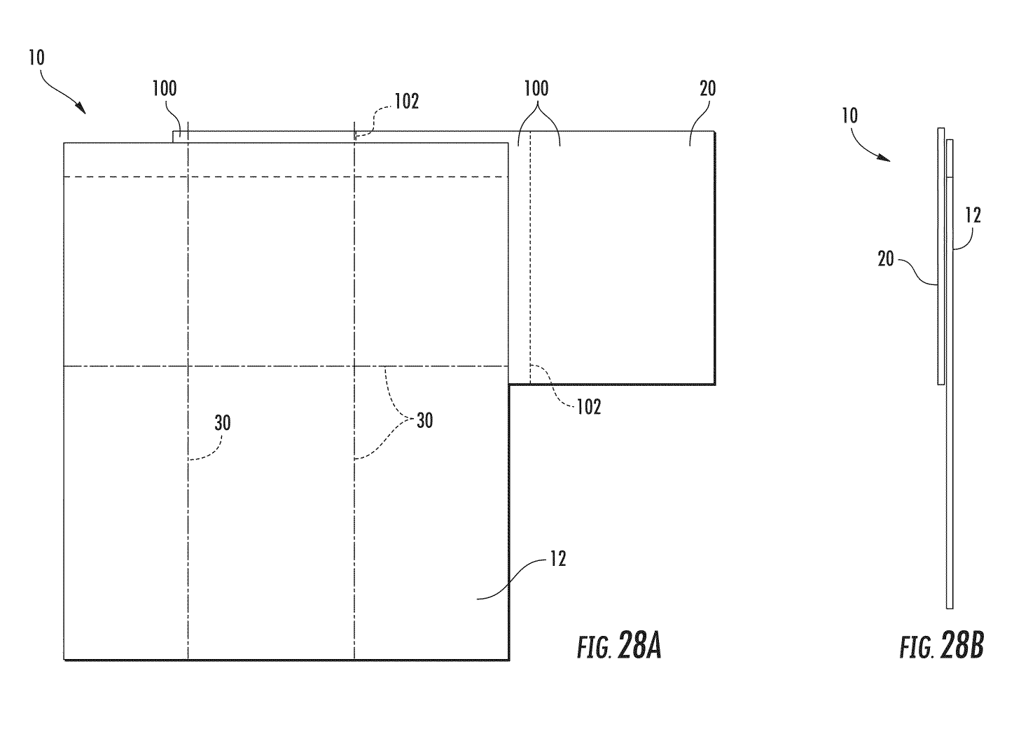

Referring to FIGS. 28A-B, a further embodiment of a greeting card flag 10 is shown, including a single panel 20 having three panel sections 100. This embodiment shows a flag portion 12 that extends beyond the boundaries of the panel section 100 to which it is attached. This flag portion 12 may be folded similarly to the flag portion of other embodiments, such as those shown in FIGS. 16A-17C, but with any extra material being folded inwards such that the flag portion 12 may be entirely contained within the boundaries of the single panel 20. This embodiment of the greeting card flag 10 may be folded into a greeting card configuration and inserted into an envelope 40, similarly to what is shown in FIGS. 17A-C. When folded in a greeting card configuration, the flag portion 12 may be substantially covered by the single panel 20 such that flag portion 12 is not readily seen when viewing the greeting card flag 10.

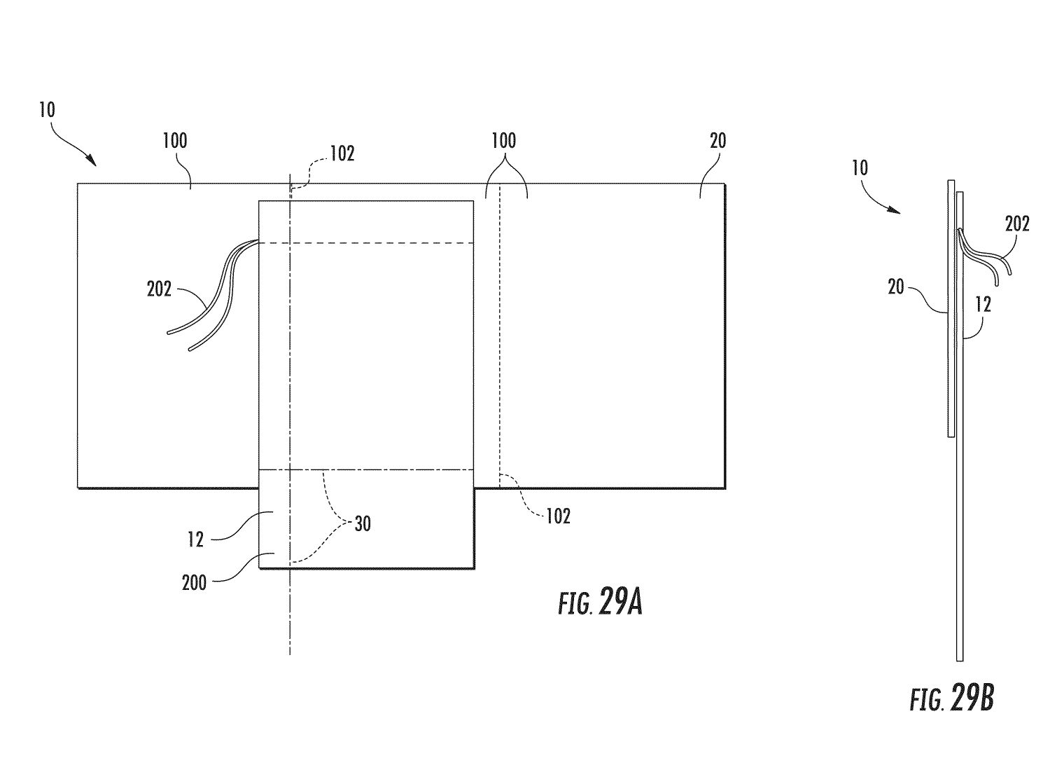

Referring to FIGS. 29A-B, an embodiment of a greeting card flag 10 is shown, including a single panel 20 having one or more panel sections 100. This embodiment shows a flag portion 12 that is a cinch bag or drawstring bag 200. This flag portion 12 that is a cinch bag or drawstring bag 200 may be folded similarly to the flag portion 12 of other embodiments, such as that shown in FIGS. 16A-17C. Referring also back to FIGS. 19A-19C, the greeting card flag 10 containing the flag portion 12 that is a cinch bag or drawstring bag 200 may be folded into a greeting card configuration and may be inserted into an envelope 40.

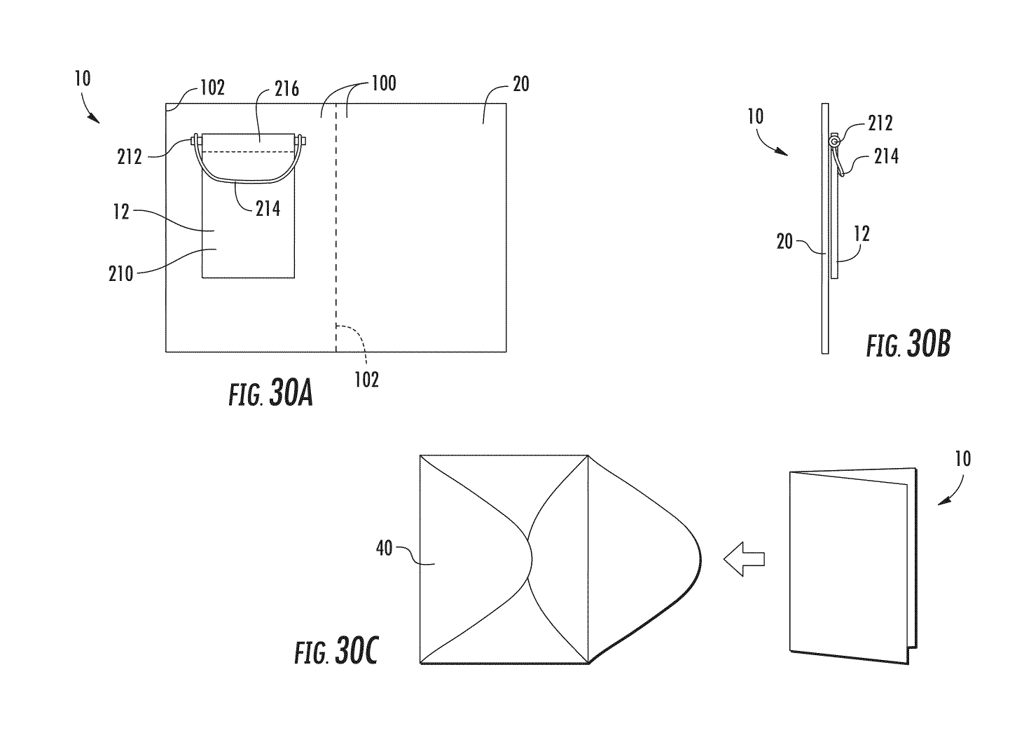

Referring to FIGS. 30A-C, an embodiment of a greeting card flag 10 is shown, including a single panel 20 having one or more panel sections 100. This embodiment shows a flag portion 12 that is a mini-flag 210. This flag portion 12 that is a mini-flag 210 may not need to be folded at all, and rather fits entirely within a single panel section 100. The flag portion 12 that is a mini-flag 210 may include a flag support 212 inserted in the support pocket 216 of the mini-flag 210. The mini-flag 210 may be secured to the panel section 100 in ways similar to those discussed in other embodiments above. The mini-flag 210 may instead be secured to the panel section 100 only through the flag support 212 being secured to the panel section 100. The greeting card flag 10 containing the flag portion 12 that is a mini-flag 210 may be folded into a greeting card configuration and may be inserted into an envelope 40.

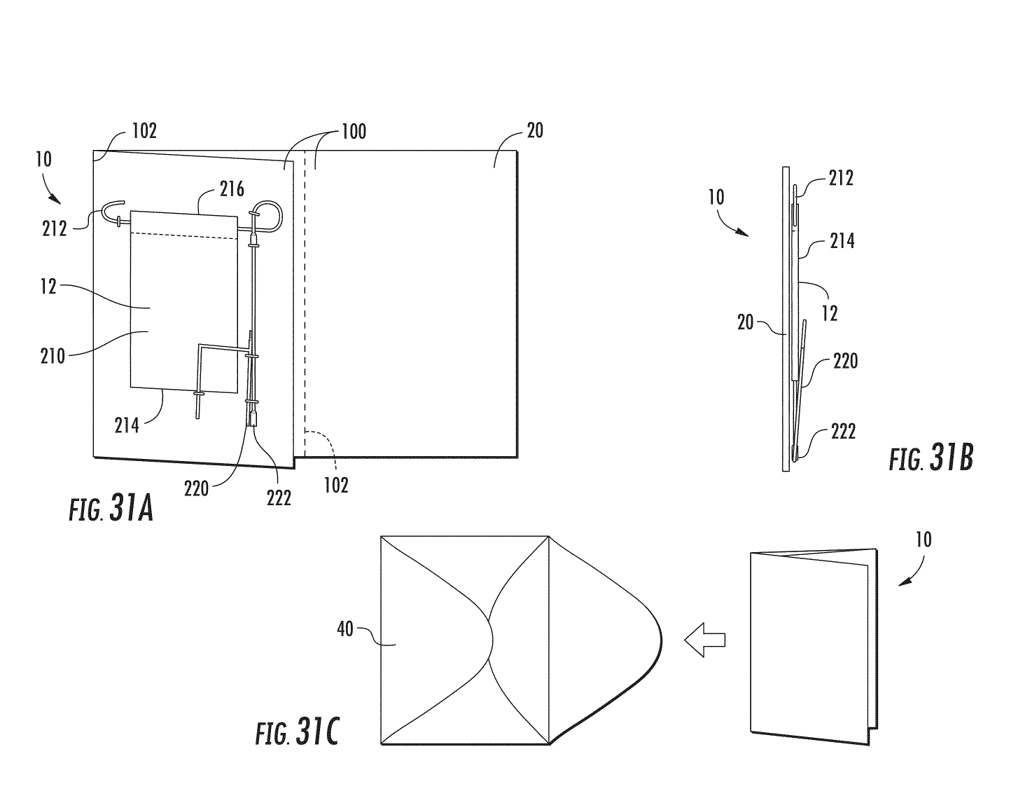

Referring to FIGS. 31A-C, an embodiment of the greeting card flag 10 is shown wherein a mini-flag 210 is included, along with a mini-flag hanger 212. The mini-flag hanger 212 is capable of converting between a compact arrangement and an in-use arrangement. When in an in-use arrangement, the height of the mini-flag hanger 212 is long enough such that when a mini-flag 210 is hung from the mini-flag hanger 212, the mini-flag 210 would hang above the support surface upon which the mini-flag hanger 212 is deployed (e.g., the mini-flag hanger 212 may be inserted into the ground or into the soil within a pot). When in a compact arrangement, the mini-flag hanger 212 is capable of fitting within the confines of the greeting card flag 10, preferably within the confines of one of the one or more sections 100. The compact arrangement may be achieved by providing a mini-flag hanger 212 that is separable into two or more pieces. Alternate embodiments (not shown) of the mini-flag hanger 212 may be extendable, such as by the use of telescoping parts or sliding parts. As shown, a lower portion 220 of the mini-flag hanger 212 is separable from an upper portion 222 of the mini-flag hanger 212 such as by a threaded coupling. At one end of the upper portion 222, the upper portion contains a threaded feature that mates with a threaded feature of one end of the lower portion 220. While a threaded coupling is herein described and depicted in FIG. 31A, other ways of separably attaching, slidingly attaching, or otherwise attaching an upper portion 222 to a lower portion 220 may be used to permit a mini-flag hanger 212 to convert between a compact arrangement and an in-use arrangement. As used herein, the term “compact arrangement” is inclusive of the term “folded arrangement” as used previously to describe flag hangers. Further, the term “in-use arrangement” is inclusive of the term “unfolded arrangement” as used previously to describe flag hangers.

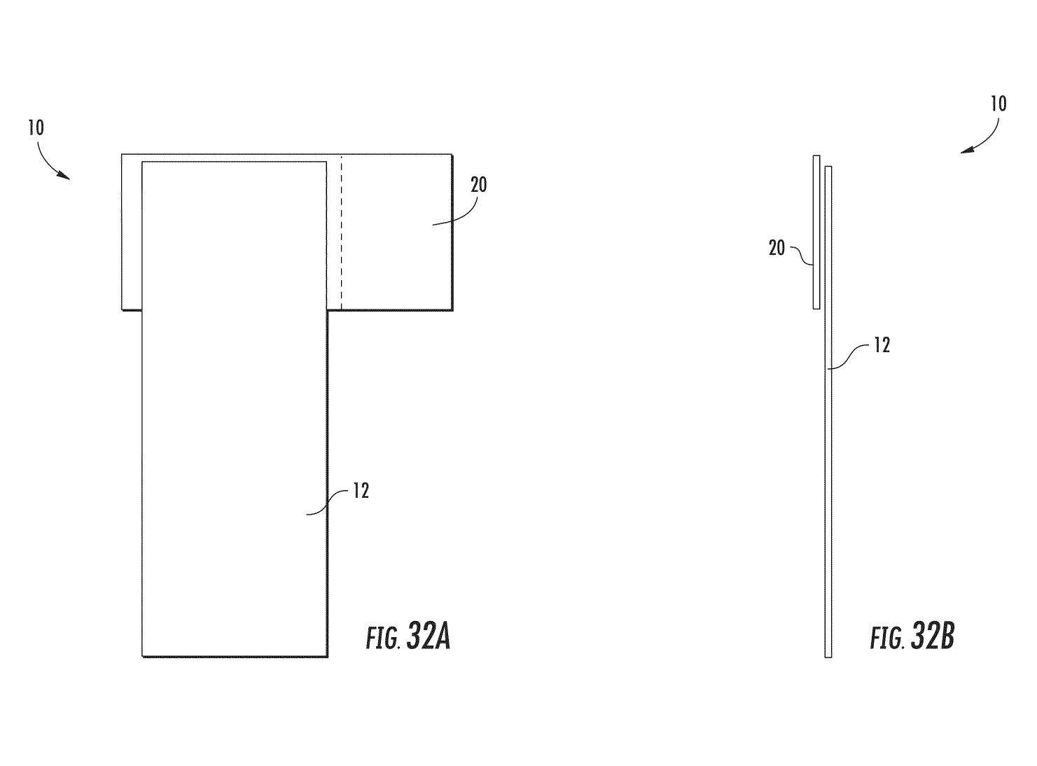

Referring to FIGS. 32A-B, an embodiment of the greeting card flag 10 is shown wherein the flag portion 12 is a scarf. The scarf may be of various shapes and sizes and may be folded up with the single panel 20 so as to be completely enveloped by the single panel 20.

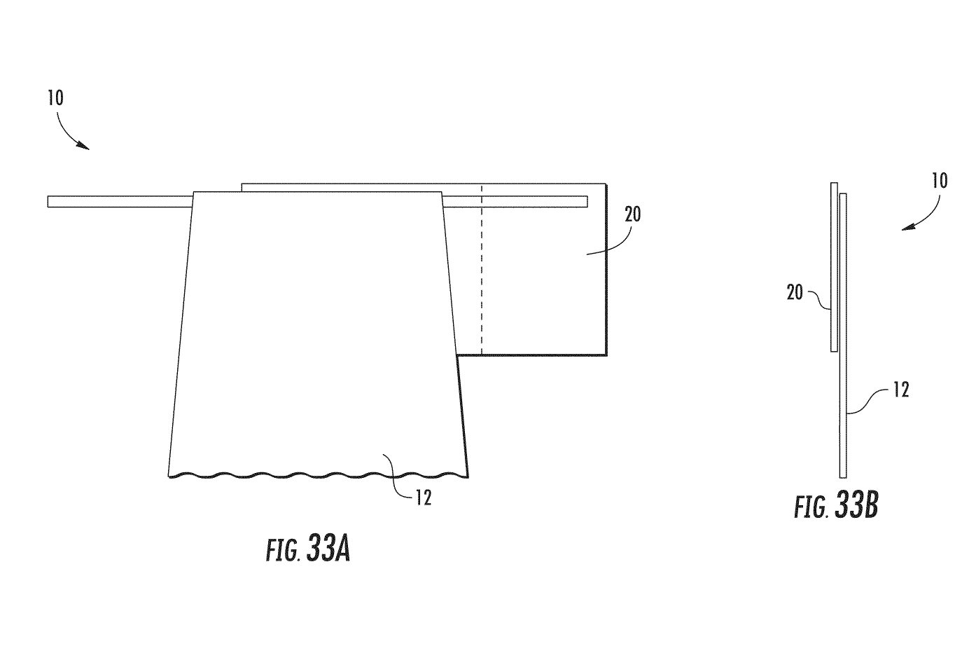

Referring to FIGS. 33A-B, an embodiment of the greeting card flag 10 is shown wherein the flag portion 12 is an apron. The apron may be of various shapes and sizes and may be folded up with the single panel 20 so as to be completely enveloped by the single panel 20. The apron shown in FIGS. 33A-B is a waist apron, but full length aprons and other aprons are contemplated by this disclosure.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. An article comprising:
a flag portion formed of a foldable material and having a first side;
one or more panels removeably attached to the first side of the flag portion and configured to facilitate folding of the article into a greeting card configuration.

2. The article of claim 1 having at least a first panel and a second panel, wherein the first panel is connected to the second panel by one or more panel connectors.

3. The article of claim 1, further comprising a flag hanger removeably attached to the one or more panels, the flag hanger being configured to support the flag portion when the flag portion is displayed.

4. The article of claim 3, being in a greeting card configuration and being located within a mailing envelope.

5. The article of claim 3, wherein the flag hanger is maneuverable between a compact arrangement where the flag hanger fits completely between the one or more panels and an in-use arrangement where the flag portion is hung from the flag hanger.

6. The article of claim 1, wherein:
the one or more panels includes a hanger section having a primary hanging point and a body section;
the flag portion is removably attached to the hanger section by a first separation line configured to facilitate separation of the hanger section from the body section;
when the hanger section and body section are unseparated, the one or more panels are folded about one or more folding lines and the article is folded into the greeting card configuration.

7. The article of claim 6,
wherein when the hanger section and body section are separated, the body section is foldable about the one or more folding lines to affect the folding of the body section into a body section greeting card configuration.

8. The article of claim 6,
wherein the one or more panels includes an envelope flap for securing the one or more panels when the one or more panels are folded into an envelope configuration.

9. The article of claim 1,
wherein the one or more panels includes an envelope flap for securing the one or more panels when the one or more panels are folded into an envelope configuration.

10. The article of claim 1, wherein the flag portion is positioned between the one or more panels when the article is in a greeting card configuration such that the flag portion is not readily visible to one looking at the article.

11. The article of claim 10, wherein the flag portion is an apron or a scarf.

12. The article of claim 1, wherein the flag portion is a bag or a towel.

13. The article of claim 1, wherein at least one of the one or more panels includes a window therein.

14. The article of claim 1, wherein the one or more panels include a separable piece.

15. The article of claim 1, including four panels positioned on the flag portion such that there is space between the panels and any outside edge of the flag portion, the flag portion being foldable about the space between the four panels.

16. The article of claim 15, wherein the four panels are interconnected by panel connectors.

17. A method of preparing a greeting card flag comprising:
providing a flag portion having a first side;
removeably attaching one or more panels to the first side of the flag portion; and
folding the flag portion into a folded configuration along at least one of a folding line and an edge of the one or more panels.

18. The method of claim 17, further comprising:
placing the flag portion, when in the folded configuration, inside an envelope.

19. The method of claim 17, wherein the act of removeably attaching includes positioning the one or more panels in a specific alignment sufficient to facilitate manipulating the greeting card flag into the folded configuration.

20. The method of claim 17, wherein the one or more panels includes an envelope flap, and further comprising folding the one or more panels into an envelope configuration and securing the envelope flap to the one or more panels.

21. A greeting card-flag combination comprising:
a flag portion formed of cloth, polyester, nylon, rayon, or a combination thereof, and
a greeting card portion removeably attached to the flag portion, the greeting card portion including a folding line;
wherein the combination is configured to be maneuvered between a first configuration where the flag portion is folded along the folding line such that the combination fits inside a standard envelope, and a second configuration where the greeting card portion is removed from the flag portion and the flag portion has been unfolded such that it can be displayed.

22. The combination of claim 21, wherein the flag portion is one of a flag, a bag, or a tea towel.
